(19) United States
(12) Patent Application Publication
(10) Pub. No.: US 2024/0354368 A1
(43) Pub. Date: Oct. 24, 2024

(54) METHOD AND SYSTEM FOR PERFORMING MATRIX MULTIPLICATION USING CONVOLUTION-SUPPORTING UNIT, DEVICE, AND MEDIUM

(71) Applicants: Beijing Youzhuju Network Technology Co., Ltd., Pinggu District (CN); Lemon Inc., Grand Cayman (KY)

(72) Inventors: Longfei BAI, Beijing (CN); Qi CHEN, Beijing (CN); Zhitao YANG, Beijing (CN); Zhilin XU, Beijing (CN); Yimin CHEN, Los Angeles, CA (US); Shan LU, Los Angeles, CA (US); Jian WANG, Beijing (CN)

(21) Appl. No.: 18/643,872

(22) Filed: Apr. 23, 2024

(30) Foreign Application Priority Data
Apr. 24, 2023 (CN) 202310457070.9

(51) Int. Cl. G06F 17/16

(52) U.S. Cl. CPC G06F 17/16

(57) ABSTRACT

A method and a system for performing a matrix multiplication operator using a unit supporting convolution operator operation, an electronic device, and a non-transitory storage medium are provided. The method includes: transforming a first matrix of the matrix multiplication operator to an input data matrix of a convolution operator; transforming a second matrix of the matrix multiplication operator to a weight matrix of the convolution operator, matrix multiplication being performed on the first matrix and the second matrix; and performing a convolution operation on the input data matrix and the weight matrix, which are obtained through transforming, of the convolution operator using the unit supporting convolution operator operation to obtain an operation result of the matrix multiplication operator.

### CROSS-REFERENCE TO RELATED APPLICATION

The present application claims priority of Chinese Patent Application No. 202310457070.9, filed on Apr. 24, 2023, and the entire content disclosed by the Chinese patent application is incorporated herein by reference as part of the present application for all purposes under the U.S. laws.

### TECHNICAL FIELD

The present disclosure relates to the field of neural network, and more particularly, relates to a method and a system for performing a matrix multiplication operator using a unit supporting convolution operator operation, an electronic device, and a non-transitory storage medium.

### BACKGROUND

Convolutional neural networks (CNNs) are a kind of feedforward neural networks including convolution computations and having a deep structure and are one of representative algorithms of deep learning.

Existing artificial intelligence (AI) tasks such as accelerated CNNs implement the use of a multiply-accumulate (MAC) array to provide high computational power for computing a convolution operator (Conv operator). A MAC operation refers to that a product result of multiplication is added with a value of an accumulator to obtain a result and then the obtained result is stored in the accumulator.

### SUMMARY

According to one aspect of the present disclosure, a method for performing a matrix multiplication operator using a unit supporting convolution operator operation is provided and comprises: transforming a first matrix of the matrix multiplication operator to an input data matrix of a convolution operator; transforming a second matrix of the matrix multiplication operator to a weight matrix of the convolution operator, matrix multiplication being performed on the first matrix and the second matrix; and performing a convolution operation on the input data matrix and the weight matrix, which are obtained through transforming, of the convolution operator using the unit supporting convolution operator operation to obtain an operation result of the matrix multiplication operator.

According to another aspect of the present disclosure, a system for performing a matrix multiplication operator using a unit supporting convolution operator operation is provided and comprises: a first transformation apparatus, configured to transform a first matrix of the matrix multiplication operator to an input data matrix of a convolution operator; a second transformation apparatus, configured to transform a second matrix of the matrix multiplication operator to a weight matrix of the convolution operator, matrix multiplication being performed on the first matrix and the second matrix; and a convolution operation apparatus, configured to perform a convolution operation on the input data matrix and the weight matrix, which are obtained through transforming, of the convolution operator using the unit supporting convolution operator operation to obtain an operation result of the matrix multiplication operator.

According to another aspect of the present disclosure, an electronic device is provided and comprises: a memory, configured to store instructions; and a processor, configured to read the instructions in the memory and execute the method according to the embodiments of the present disclosure.

According to another aspect of the present disclosure, a non-transitory storage medium is provided, instructions are stored on the non-transitory storage medium, and the instructions, when read by a processor, causes the processor to perform the method according to the embodiments of the present disclosure.

### BRIEF DESCRIPTION OF DRAWINGS

In order to more clearly illustrate the technical solutions of the embodiments of the present disclosure or the prior art, the drawings required for describing the embodiments or the prior art will be briefly described in the following; it is obvious that the drawings in the following description are just some embodiments of the present disclosure, those skilled in the art can obtain other drawing(s) according to these drawings, without any inventive work.

FIGS. 1A-1B illustrate schematic diagrams of a convolution process of a convolutional neural network in the prior art;

FIG. 2A illustrates a schematic process of performing a convolution operation on an input data cube and a weight cube to obtain an output data cube;

FIG. 2B illustrates an intuitive schematic diagram of an atomic operation of a convolution operation performed on an input data cube and a weight cube on hardware using a unit supporting Conv operator operation;

FIG. 2C illustrates an intuitive schematic diagram of a stripe operation of a convolution operation performed on an input data cube and a weight cube on hardware using a unit supporting Conv operator operation;

FIG. 2D illustrates an intuitive schematic diagram of a block operation of a convolution operation performed on an input data cube and a weight cube on hardware using a unit supporting Conv operator operation;

FIG. 2E illustrates an intuitive schematic diagram of a channel operation of a convolution operation performed on an input data cube and a weight cube on hardware using a unit supporting Conv operator operation;

FIG. 2F illustrates a schematic diagram of output cubes after convolution and an output order of the output cubes;

FIG. 3 illustrates a schematic diagram of an example matrix multiplication operation process of a matrix A and a matrix B;

FIG. 4 illustrates a flowchart of a method 400 for performing a matrix multiplication operator using a unit supporting convolution operator operation according to an embodiment of the present disclosure;

FIG. 5A illustrates a flowchart of a method for performing a matrix multiplication operator using a unit supporting convolution operator operation according to another embodiment of the present disclosure;

FIG. 5B illustrates a schematic diagram of a parameter mapping relationship between matrix multiplication and a convolution operator in case of mapping a count of rows of a first matrix of a matrix multiplication operator to a width parameter of an input data matrix of the convolution operator according to another embodiment of the present disclosure as illustrated in FIG. 5A;

FIG. 6A illustrates another flowchart of a method for performing a matrix multiplication operator using a unit supporting convolution operator operation according to another embodiment of the present disclosure;

FIG. 6B illustrates a schematic diagram of an input data matrix and a weight matrix of a convolution operator to which a first matrix and a second matrix of a matrix multiplication operator are mapped;

FIG. 6C illustrates a schematic diagram of performing convolution by a matrix multiplication (i.e., MAC) unit of a unit supporting Conv operator operation;

FIG. 7 illustrates a flowchart of directly supporting a data format of a matrix for matrix multiplication on deep learning accelerator (DLA) hardware in performing a matrix multiplication operator using a unit supporting convolution operator operation according to another embodiment of the present disclosure;

FIG. 8 illustrates a schematic diagram of a fetch sequence and memory mapping of a first matrix of a matrix multiplication operator according to an embodiment of the present disclosure;

FIG. 9 illustrates a schematic diagram of a fetch sequence and memory mapping of a second matrix of a matrix multiplication operator according to an embodiment of the present disclosure;

FIG. 10 illustrates a schematic diagram of a storage order and memory mapping of a result matrix of a matrix multiplication operator according to an embodiment of the present disclosure;

FIG. 11 illustrates a block diagram of a system for performing a matrix multiplication operator using a unit supporting convolution operator operation according to an embodiment of the present disclosure;

FIG. 12 illustrates a block diagram of an example electronic device suitable for implementing an embodiment of the present disclosure; and

FIG. 13 illustrates a schematic diagram of a non-transitory computer readable storage medium according to an embodiment of the present disclosure.

### DETAILED DESCRIPTION

Examples of the present disclosure are illustrated in the accompanying drawings with reference to specific embodiments of the present disclosure in detail. Although the present disclosure will be described in combination with the specific embodiments, it will be appreciated that the present disclosure is not intended to be limited to the described embodiments. On the contrary, it is intended to cover changes, modifications, and equivalents included within the spirit and scope of the present disclosure as defined by the appended claims. It should be noted that all method steps described herein can be implemented by any functional block or functional arrangement, and any functional block or functional arrangement can be implemented as a physical entity or a logical entity, or a combination of both.

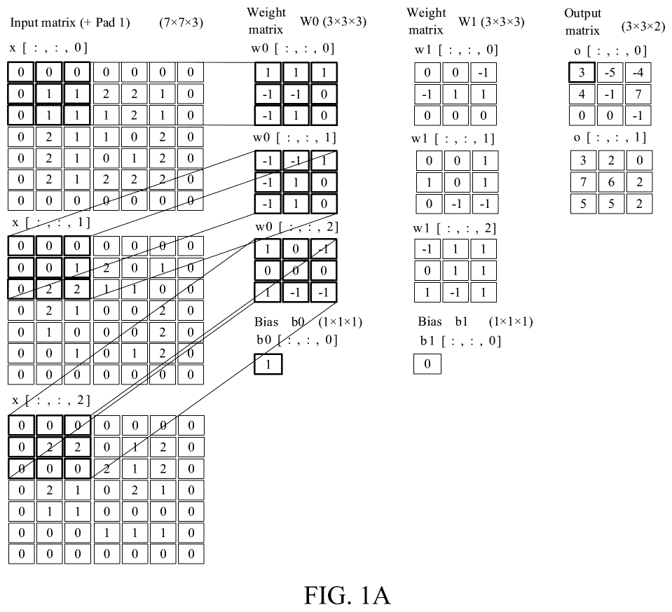

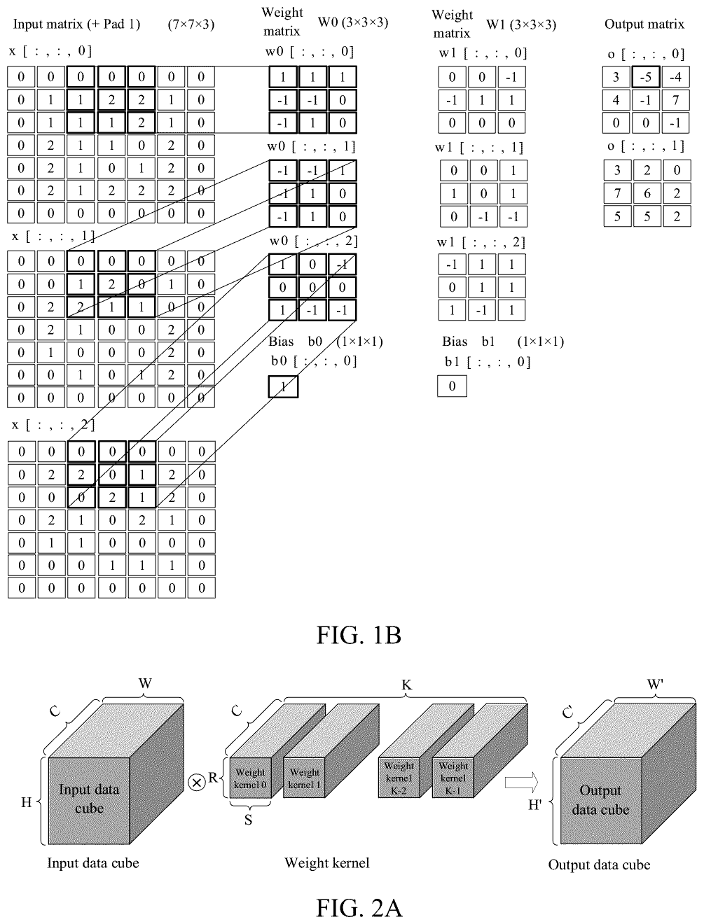

FIGS. 1A-1B illustrate schematic diagrams of a convolution process of a convolutional neural network in the prior art.

As shown in FIG. 1A, it is assumed that input data is a 7×7×3 three-dimensional matrix (an input data cube, namely Datain Cube)(Height (Datain Height)=7, Width (Datain Width)=7, Channel (Datain Channel)=3). A first channel of the input data is a 7×7 two-dimensional matrix x [:,:,0] as shown in the upper part of the left side of FIG. 1A, a second channel of the input data is a 7×7 two-dimensional matrix x [:,:,1] as shown in the middle part of the left side of FIG. 1A, and a third channel of the input data is a 7×7 two-dimensional matrix x [:,:,2] as shown in the lower part of the left side of FIG. 1A.

A weight matrix (Weight Cube) to be convolved with the input data includes 2 convolution kernel matrices (also referred to as filters) w0 and w1, i.e., Weight Kernel=2. Each convolution kernel matrix is a 3×3×3 three-dimensional matrix (Height (Weight Height)=3, Width (Weight Width)=3, Channel (Weight Channel)=3), a first channel of a first convolution kernel matrix is a 3×3 two-dimensional matrix w0 [:,:,0], a second channel of the first convolution kernel matrix is a 3×3 two-dimensional matrix w0 [:,:,1], and a third channel of the first convolution kernel matrix is a 3×3 two-dimensional matrix w0 [:,:,2]. Note that the count (i.e., 3) of channels of the convolution kernel matrix here is certainly equal to the count (i.e., 3) of channels of the input data, because a product of the first channel of the input data and the first channel of the first convolution kernel matrix is to be computed, then a product of the second channel of the input data and the second channel of the first convolution kernel matrix is to be computed, and then a product of the third channel of the input data and the third channel of the first convolution kernel matrix is to be computed, and finally the three products of the 3 channels are accumulated. A first channel of the second convolution kernel matrix is a 3×3 two-dimensional matrix w1 [:,:,0], a second channel of the second convolution kernel matrix is a 3×3 two-dimensional matrix w1 [:,:,1], and a third channel of the second convolution kernel matrix is a 3×3 two-dimensional matrix w1 [:,:,2].

Note that, as shown in FIG. 1A, each convolution kernel here further includes a bias: b0 and b1, respectively. The bias is to be added after the accumulation of the products of three channels.

An output matrix is a 3×3×2 three-dimensional matrix (an output data cube, namely Dataout Cube)(Height (Dataout Height)=3, Width (Dataout Width)=3, Channel (Dataout Channel)=2). The Dataout Channel here actually corresponds to the count of the kernels of the weight matrix (i.e., Weight Kernel), both being 2. A 3×3 matrix of a first channel of the output matrix is o [:,:,0], and a 3×3 matrix of a second channel of the output matrix is o [:,:,1].

Next, the specific convolution process as shown in FIG. 1A is described below by way of example.

In case of a convolution window size being 3×3, firstly, corresponding elements respectively in the 3×3 matrix in the two-dimensional matrix of the first channel of the input data and the 3×3 matrix of the convolution kernel of the first channel are multiplied and accumulated, i.e., 0×1+0×1+0×1+0×(−1)+1×(−1)+1×0+0×(−1)+1×1+1×0=0; then corresponding elements respectively in the 3×3 matrix in the two-dimensional matrix of the second channel of the input data and the 3×3 matrix of the convolution kernel of the second channel are multiplied and accumulated, i.e., 0×(−1)+0×(−1)+0×1+0×(−1)+0×1+1×0+0×(−1)+2×1+2×0=2; and then corresponding elements respectively in the 3×3 matrix in the two-dimensional matrix of the second channel of the input data and the 3×3 matrix of the convolution kernel of the second channel are multiplied and accumulated (i.e., to obtain an inner product of the two matrices), i.e., 0×1+0×0+0×(−1)+0×0+2×0+2×0+0×1+0×(−1)+0×(−1)=0.

The product results of the three channels are then accumulated (i.e., multiply and accumulate operations are performed), i.e., 0+2+0=2, and then added with bias b0=1, i.e., 2+1=3. Therefore, a first value [0, 0, 0] of the 3×3 matrix o [:,:,0] of the first channel of the output matrix is 3.

Then, as shown in FIG. 1B, as per sliding stride (e.g., 2), the window is moved rightwards by several elements, the count of which is sliding stride (e.g., 2), and then the second 3×3 matrix is fetched from each channel of the input data cube and then is multiplied with the weight matrix of the corresponding first kernel (i.e., to obtain an inner product of the two matrices) to obtain a second value [0, 1, 0] of the 3×3 matrix o [:,:,0] of the first channel of the output matrix as follows: [0, 1, 0]=−5. By analogy, all values of the 3×3 matrix o [:,:,0] of the first channel of the output matrix are obtained. It should be noted that “the weight matrix of the corresponding first kernel” is the above mentioned “first convolution kernel matrix”.

Then, the convolution of the input matrix and the weight matrix w1 of the second kernel can be computed in the same way to obtain all values of the 3×3 matrix o [:,:,1] of the second channel of the output matrix. It should be noted that “the w weight matrix w1 of the second kernel” is the above mentioned “second convolution kernel matrix”.

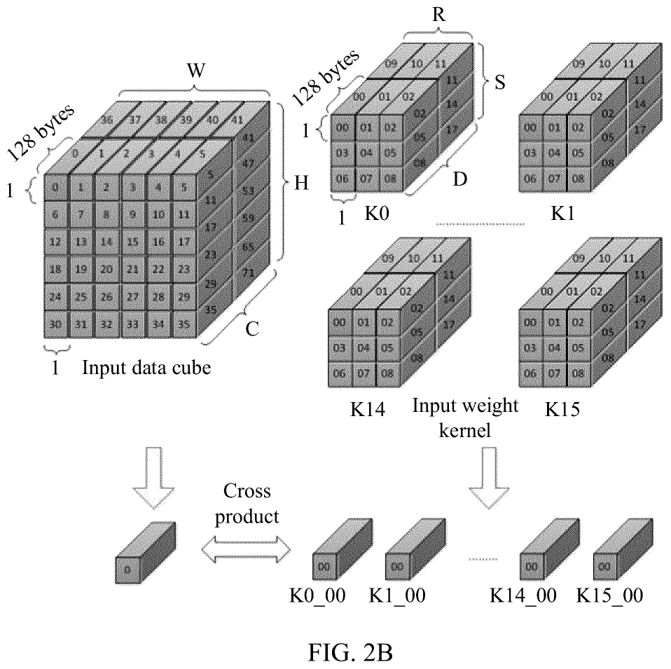

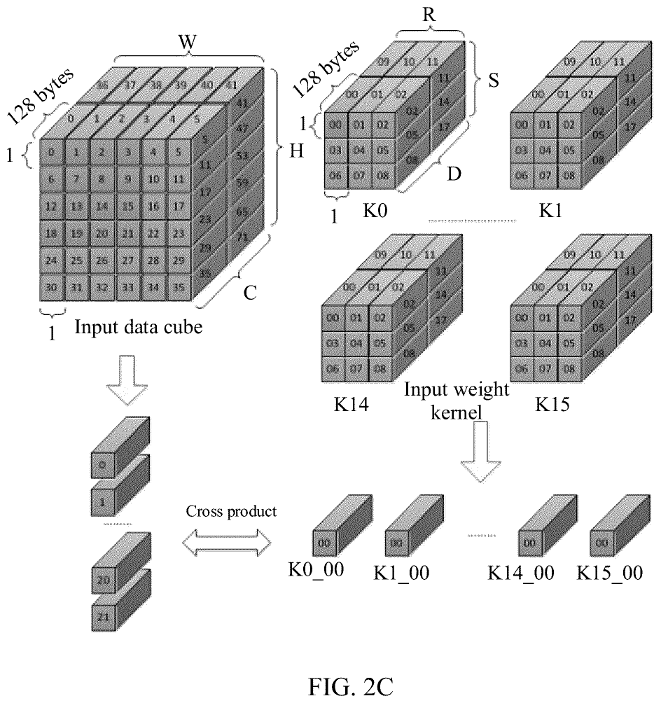

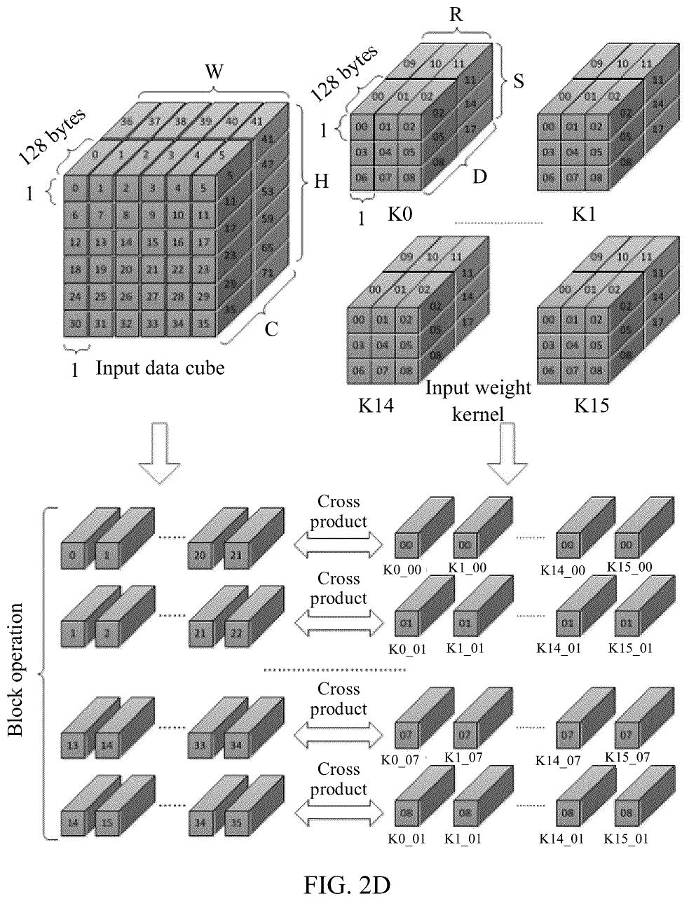

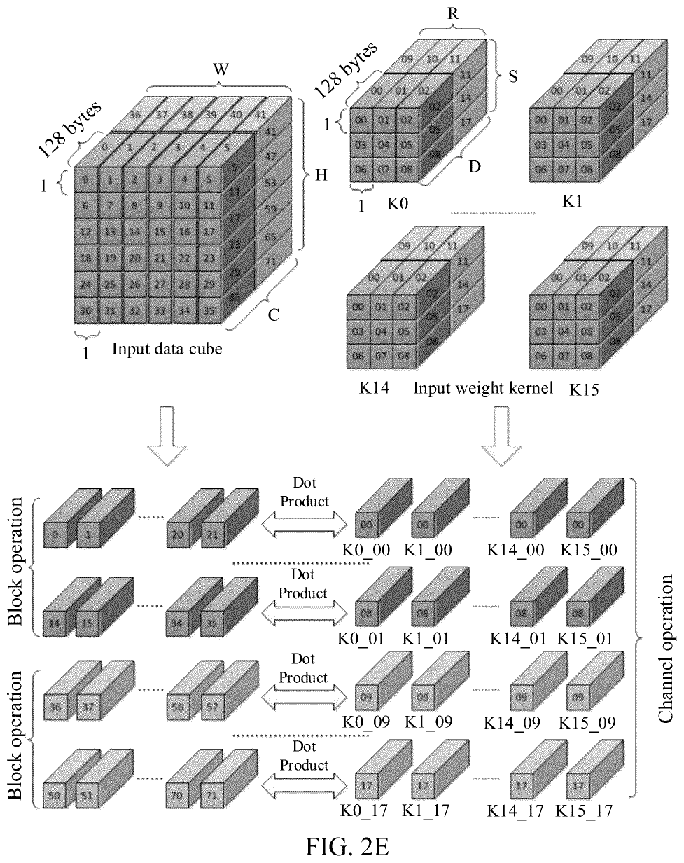

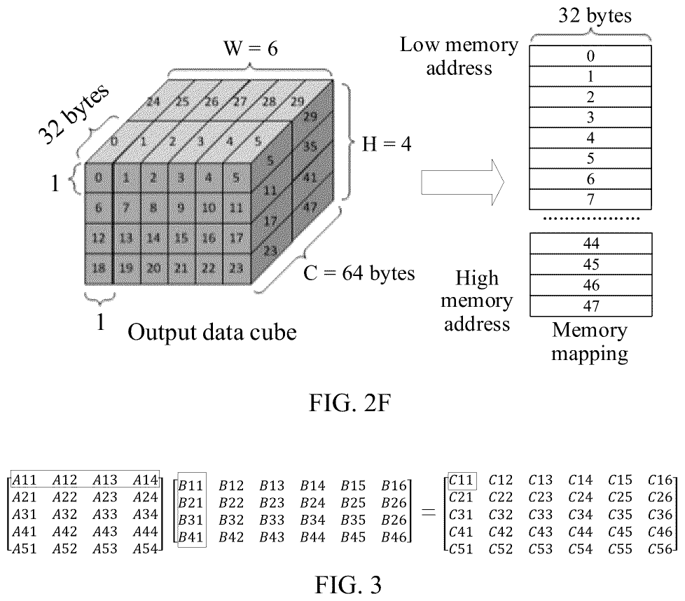

FIGS. 2A-2F illustrate intuitive schematic diagrams of performing a convolution operation on an input data cube and a weight cube on hardware using a unit supporting Conv operator operation.

FIG. 2A illustrates a schematic process of performing a convolution operation on an input data cube and a weight cube to obtain an output data cube.

As shown in FIG. 2A, a convolution operator input includes: input data and weight data. A size of the input data cube is W×H×C, where W represents a width, H represents a height, and C represents the count of channels, and all are positive integers.

A size of a weight kernel is R×S×C, where R represents a height, S represents a width, and C represents the count of channels, and all are positive integers.

The total number of weight kernels is K, and is a positive integer.

A size of the output data cube obtained after the convolution of the input data cube and the weight cube is W′×H′×C′, where W′ represents a width, H′ represents a height, and C′ represents the count of channels, and all are positive integers.

To complete the convolution operation described above, a convolution pipeline uses a method called direct convolution. The key idea of the direct convolution is to group multiplication operations from each convolution kernel such that each group includes 64 multiplication operations. The basic rules are as follows.
1. All pieces of multiply-accumulate (MAC) hardware are assigned to 16 subunits. A subunit is called a MAC unit and has hardware for 64 int 16/fp16 MACs or 128 int8 MACs, where int16, fp16, and int8 are different data formats. Note that due to implementation on hardware, the format of the stored data, methods and orders of storing in and fetching from a memory, and the like need to be considered.
2. A set of MAC units is referred to as a MAC unit array.
3. For int16, fp16, and int8, all input data cubes are divided into small cubes with 1×1×64 elements. That is, the count of channels of the small cube is 64, and both the width and the height of the small cube are 11. If the format of each number in the small cube is int16 or fp16, the size of the number is 2 bytes, and therefore, the length in the channel direction is 128 bytes. If the format of each number in the small cube is int8, the size of the number is 1 byte, and therefore, the length in the channel direction is 64 bytes.
4. All weight data cubes are divided into small cubes with 1×1×64 elements, and the formats of the numbers in the small cubes comprise int16, fp16, and int8. That is, for the small cube taken from the weight data cube of each kernel, the count of channels of the small cube is 64, and both of the width and the height are 1. If the format of each number in the small cube is int16 or fp16, the size of the number is 2 bytes, and therefore, the length in the channel direction is 128 bytes. If the format of each number in the small cube is int8, the size of the number is 1 byte, and therefore, the length in the channel direction is 64 bytes.
5. A small input data cube is multiplied by a small weight data cube to obtain products and the products are added (i.e., multiply-accumulate). These multiplications and additions are performed within one MAC unit.
6. These computation operations are combined into 4 operation levels, i.e., an atomic operation, a stripe operation, a block operation, and a channel operation.

The four operations are introduced below by taking an accuracy mode of int16 data format as an example.

FIG. 2B illustrates an intuitive schematic diagram of an atomic operation of a convolution operation performed on an input data cube and a weight cube on hardware using a unit supporting Conv operator operation.

The atomic operation is a basic step of the direct convolution. In an atomic operation, a 1×1×64 weight cube from a single weight kernel is cached in each MAC unit. Therefore, weights from 16 int16/fp16 kernels or 32 int8 kernels are cached in 16 MAC units. All the MAC units share the feature data of a 1×1×64 atom cube.

As shown in FIG. 2B, if the format of each number in the cube is int16, the size of the number is 2 bytes, and therefore, the length in the channel direction is 128 bytes.

The MAC unit performs the computations mentioned in above rule 5. As shown in FIG. 2B, one MAC unit multiplies one small input data cube 0 by one small weight data cube K0_00, one MAC unit multiplies one small input data cube 0 by one small weight data cube K1_00, . . . , one MAC unit multiplies one small input data cube 0 by one small weight data cube K14_00, and one MAC unit multiplies one small input data cube 0 by one small weight data cube K15_00. An output of each MAC unit is called a partial sum. The above computations need to be completed in 1 cycle, resulting in 16 partial sums per cycle. The partial sums are transmitted to a convolution accumulator module for further computation.

FIG. 2C illustrates an intuitive schematic diagram of a stripe operation of a convolution operation performed on an input data cube and a weight cube on hardware using a unit supporting Conv operator operation.

The stripe operation combines a set of atomic operations from several convolutions. During one stripe operation, the weight data in the MAC unit array remains unchanged. The input data slides along the input data cube. That is, the small input data cube 0 is multiplied by one small weight data cube K0_00, one small input data cube 1 is multiplied by the small weight data cube K0_00, one small input data cube 2 is multiplied by the small weight data cube K0_00, one small input data cube 3 is multiplied by the small weight data cube K0_00, one small input data cube 6 is multiplied by the small weight data cube K0_00, one small input data cube 7 is multiplied by the small weight data cube K0_00, . . . , one small input data cube 20 is multiplied by the small weight data cube K0_00, and one small input data cube 21 is multiplied by the small weight data cube K0_00. Herein, it is assumed that a sliding window is 4×4.

Note that the partial sums in one stripe operation cannot be added because they correspond to different points in the output cube.

The length of the stripe operation is limited. A lower limit is 16 due to an internal bandwidth for extracting weights for next stripe operation. Due to a buffer size in the accumulator, an upper limit is 32. In some extreme cases, the length may be less than the lower limit.

FIG. 2C shows an example of a stripe operation including 16 atomic operations. In this case, a padding size is 0. Note that this is not progressive scanning for the input data cube. Although in general, a stripe is firstly scanned along the W dimension. FIG. 2C shows one example without padding, and therefore, the last two columns are not part of the first stripe (using 3×3 kernels, no padding, input data W=6, and output data W=4).

FIG. 2D illustrates an intuitive schematic diagram of a block operation of a convolution operation performed on an input data cube and a weight cube on hardware using a unit supporting Conv operator operation.

A block operation is a higher-level operation composed of a plurality of stripe operations. During the block operation, each kernel in a kernel group uses R×S×64 weight elements and the input element data of one small cube, and its size is appropriate to ensure that results can be added across stripe operations and accumulated into 16-32 element accumulator.

All stripe operations in one block operation have the same atomic operation. In the convolution accumulator, each stripe operation adds the partial sums from the same block operation together. These results are called accumulated sums.

FIG. 2E illustrates an intuitive schematic diagram of a channel operation of a convolution operation performed on an input data cube and a weight cube on hardware using a unit supporting Conv operator operation.

A channel operation is a higher-level operation. The channel operation includes (C+63)/64 block operations. The block operations in one channel operation are similar except for the coordinate of the channel direction.

All partial sums of one channel operation may be added together by a stripe operation. After one channel operation, the result in the convolution accumulator is a convolution result.

After one channel operation is completed, the accumulator is unloaded and sent to a postprocessor to vacate space for next channel operation.

After the channel operation is completed, a grouping operation, which is a higher-level operation than the channel operation, is performed to complete all computations of a group of kernels. The channel operation is included in the grouping operation. After the grouping operation, the output data forms a W×H×K′ output matrix. Here, K′ refers to a kernel size of the kernel group. One kernel group comprises kernels to be processed at one time, one for each MAC unit.

Usually, there are 16 identical multiplication arrays for computing the multiplications of 16 different kernels, and there are 64 multiplications and a 64-input addition tree in each multiplication array to perform multiplication and accumulation.

When computing direct convolution, feature/pixel data (i.e., data of elements of the input data matrix) of 128 bytes is needed for each cycle, i.e., 64 pieces of channel data (because in case of int16/fp16, each data occupies 2 bytes). Therefore, during storage, each memory bank only needs to store 64 pieces of channel data, and in use, the data of a specified memory bank can be selected by a multiplexer (MUX). When writing the results back, 16 pieces of feature data need to be written back for each cycle.

FIG. 2F illustrates a schematic diagram of output cubes after convolution and an output order of the output cubes.

The order mentioned in each operation is mainly directed to the input feature data and the weight data, not the output order. A sequence of the output data is very simple. It follows the order C′(K′)->W->H->C(K). Here, C′ or K′ refers to a size of the kernel group, and is 16 for int16/fp16 and 32 for int8.

Existing AI tasks such as accelerated CNNs implement the MAC array, provide high computational power for computing a convolution operator (Conv operator), but only support the Conv operator and cannot accelerate a matrix multiplication operator which also has a large number of MAC operations. The matrix multiplication operator is extensively applied to data centers and computing scenarios of high-performance computing (HPC) such as AI reasoning training, basic linear algebra subprograms (BLAS), computer vision, and scientific computation and also needs to be accelerated.

The present disclosure is intended to multiplex and improve the mature CNN accelerator to handle a large number of matrix multiplication operators in various application scenarios to better unload and accelerate tasks of a host central processing unit (CPU).

As described above, during the computing process, the Conv operator involves the multiply-accumulate (MAC) computations between the channels of the input matrix and the channels of the weight matrix, i.e., sums the inner products of the channels of the input matrix and the corresponding channels of the weight matrix.

Matrix multiplication involves a large number of data multiplexing and multiply-accumulate (MAC) operations. Therefore, the present disclosure is intended to map the matrix multiplication to the Conv operator based on the similarity between the matrix multiplication and the Conv operator. Thus, the matrix multiplication is accelerated by using a CNN accelerator only processing the Conv operator.

Next, how to accelerate the matrix multiplication by using the CNN accelerator only processing the Conv operator is described in detail.

FIG. 3 illustrates a schematic diagram of an example matrix multiplication operation process of a matrix A and a matrix B.

It is assumed that two matrices to be multiplied in the matrix multiplication are a matrix A and a matrix B, where the matrix A is an M×K two-dimensional matrix and the matrix B is a K×N two-dimensional matrix, where M, K, and N are positive integers; and a result matrix C obtained by performing the matrix multiplication operation on the matrix A and the matrix B is an M×N two-dimensional matrix. It is well known that to multiply two matrices, a count of columns of the matrix A needs to be equal to a count of rows of the matrix B.

As shown in FIG. 3, taking for example M=5, K=4, and N=6, that is, the matrix A is a 5×4 two-dimensional matrix

$$[ \begin{matrix}A 11 & A 12 & A 13 & A 14 \\ A 21 & A 22 & A 23 & A 24 \\ A 31 & A 32 & A 33 & A 34 \\ A 41 & A 42 & A 43 & A 44 \\ A 51 & A 52 & A 53 & A 54\end{matrix} ] ,$$

and the matrix B is a 4×6 two-dimensional matrix

$$[ \begin{matrix}B 11 & B 12 & B 13 & B 14 & B 15 & B 16 \\ B 21 & B 22 & B 23 & B 24 & B 25 & B 26 \\ B 31 & B 32 & B 33 & B 34 & B 35 & B 26 \\ B 41 & B 42 & B 43 & B 44 & B 45 & B 46\end{matrix} ] .$$

The result matrix C is a 5×6 two-dimensional matrix

$$[ \begin{matrix}C 11 & C 12 & C 13 & C 14 & C 15 & C 16 \\ C 21 & C 22 & C 23 & C 24 & C 25 & C 26 \\ C 31 & C 32 & C 33 & C 34 & C 35 & C 36 \\ C 41 & C 42 & C 43 & C 44 & C 45 & C 46 \\ C 51 & C 52 & C 53 & C 54 & C 55 & C 56\end{matrix} ] .$$

In the above matrix, C11=A11×B11+A12×B21+A13×B31+A14×B41. C12=A11×B12+A12×B22+A13×B32+A14×B42, and so on. C21=A21×B11+A22×B21+A23×B31+A24×B41, C22=A21×B12+A22×B22+A23×B32+A24×B42, and so on. All computations of the matrix multiplication are not described redundantly here.

In short, the matrix multiplication also has a large number of multiply-accumulate (MAC) computations.

Therefore, it is intended to map the matrix multiplication to the Conv operator based on the similarity between the matrix multiplication and the Conv operator. Thus, the matrix multiplication is accelerated by using a CNN accelerator only processing the Conv operator.

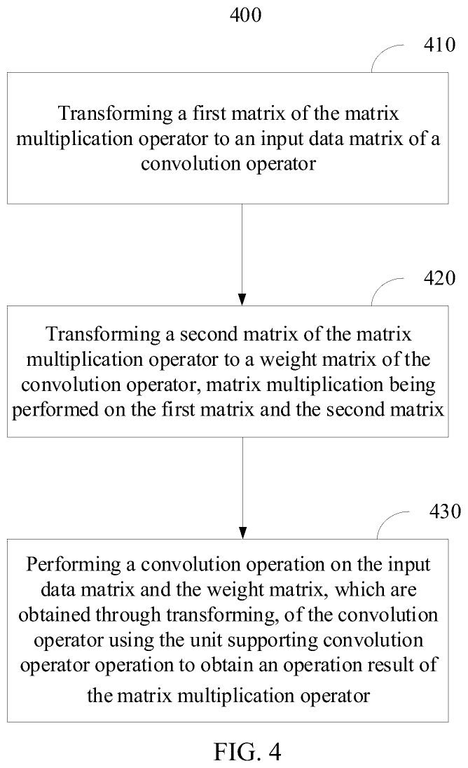

FIG. 4 illustrates a flowchart of a method 400 for performing a matrix multiplication operator using a unit supporting convolution operator operation according to an embodiment of the present disclosure.

As shown in FIG. 4, the method 400 for performing a matrix multiplication operator using a unit supporting convolution operator operation includes the following steps.

At step 410, transforming a first matrix of the matrix multiplication operator to an input data matrix of a convolution operator.

The matrix multiplication operator typically is multiplying 2 matrices, e.g., multiplying a first matrix and a second matrix.

At step 420, transforming a second matrix of the matrix multiplication operator to a weight matrix of the convolution operator.

Matrix multiplication is performed on the first matrix and the second matrix.

At step 430, performing a convolution operation on the input data matrix and the weight matrix, which are obtained through transforming, of the convolution operator using the unit supporting convolution operator operation to obtain an operation result of the matrix multiplication operator.

In this way, because both of the matrix multiplication operator and the convolution operator have a large number of multiply-accumulate (MAC) computations and the multiply-accumulate of the convolution operator is mainly reflected in the multiply-accumulate between the input data matrix and the weight matrix of the convolution operator, the first matrix of the matrix multiplication operator is transformed to the input data matrix of the convolution operator and the second matrix of the matrix multiplication operator is transformed to the weight matrix of the convolution operator, and then the convolution operation may be performed on the input data matrix and the weight matrix, which are obtained through transforming, of the convolution operator using the unit supporting convolution operator operation to obtain the operation result of the matrix multiplication operator. Thus, hardware and software overheads can be saved and the computing performance can be improved.

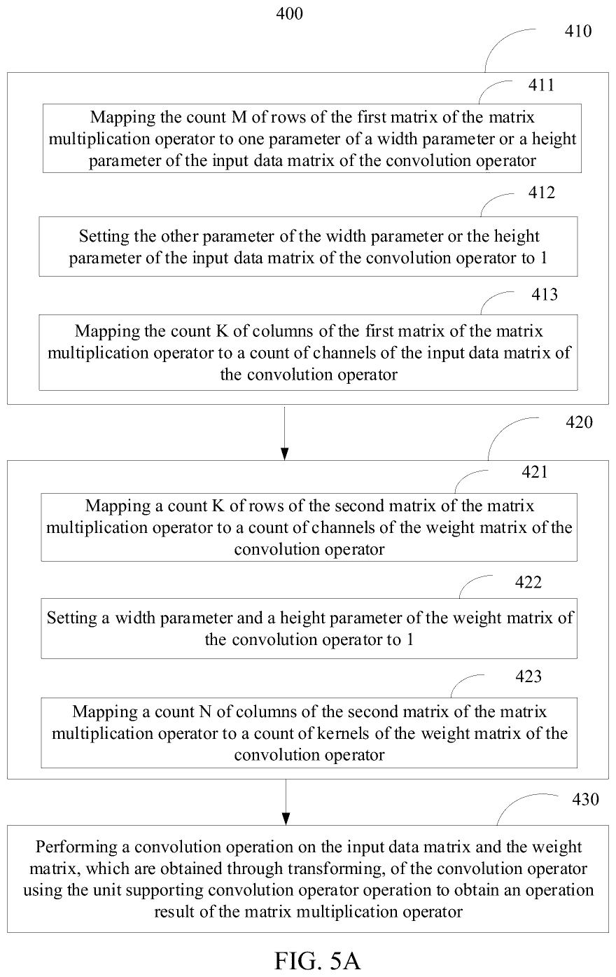

FIG. 5A illustrates a flowchart of a method 400 for performing a matrix multiplication operator using a unit supporting convolution operator operation according to another embodiment of the present disclosure.

For a convolution (Conv) operator, input data has an input data cube (or matrix) (Datain Cube) and a weight cube (matrix) (Weight Cube).

Parameters of the input data cube include a data input width (Datain Width) (i.e., a width parameter), a data input height (Datain Height) (i.e., a height parameter), and a data input channel (Datain Channel) (i.e., a channel parameter). Herein, note that the parameter refers to the size. For example, the width parameter refers to a width size of the matrix, i.e., the quantity of elements in the width dimension; the height parameter refers to a height size of the matrix, i.e., the quantity of elements in the height dimension; and the channel parameter refers to a channel size of the matrix, i.e., the quantity of elements (i.e., the quantity of channels) in the channel dimension.

Parameters of the weight cube include a weight width (Weight Width), a weight height (Weight Height), a weight channel (Weight Channel), and a weight kernel (Weight Kernel).

Parameters of an output data cube (Dataout Cube) of the convolution operator include a data output width (Dataout Width), a data output height (Dataout Height), and a data output channel (Dataout Channel).

It is assumed that a count of rows of the first matrix of the matrix multiplication operator to be computed is M, a count of columns of the first matrix of the matrix multiplication operator is K, a count of rows of the second matrix of the matrix multiplication operator to be computed is K, and a count of columns of the second matrix of the matrix multiplication operator is N, where M, K, and N are positive integers.

In FIG. 5A, the step 410 of transforming the first matrix of the matrix multiplication operator to the input data matrix of the convolution operator includes the following steps.

At step 411, mapping the count M of rows of the first matrix of the matrix multiplication operator to one parameter of a width parameter or a height parameter of the input data matrix of the convolution operator.

At step 412, setting the other parameter of the width parameter or the height parameter of the input data matrix of the convolution operator to 1.

Generally speaking, because the first matrix of the matrix multiplication operator is two-dimensional and the input data matrix of the convolution operator is three-dimensional, the two-dimensional matrix needs to be firstly mapped to the three-dimensional matrix, so that the parameter (the quantity of elements) of one dimension of the input data matrix of the convolution operator is set to 1. Because the MAC operation must include the computation in the channel dimension, it is sufficient to take one dimension from the group consisting of the width dimension and the height dimension of the input data matrix of the convolution operator, and the quantity of elements of the other dimension of the group consisting of the width dimension and the height dimension is set to 1, which is equivalent to removing the other dimension, and thus, the matrix becomes two-dimensional.

Note that if the count M of rows of the first matrix of the matrix multiplication operator is mapped to the width parameter of the input data matrix of the convolution operator, the height parameter of the input data matrix of the convolution operator is set to 1. In another aspect, if the count M of rows of the first matrix of the matrix multiplication operator is mapped to the height parameter of the input data matrix of the convolution operator, the width parameter of the input data matrix of the convolution operator is set to 1.

The two mapping methods: one method is to map the count M of rows of the first matrix of the matrix multiplication operator to the width parameter of the input data matrix of the convolution operator and the other method is to map the count M of rows of the first matrix of the matrix multiplication operator to the height parameter of the input data matrix of the convolution operator, can provide equal hardware execution efficiency and performance. A particular mapping method can be selected with considerations in terms of design and implementation logic of hardware units such as data organization and process control that multiplex a Conv operator.

At step 413, mapping the count K of columns of the first matrix of the matrix multiplication operator to a count of channels of the input data matrix of the convolution operator.

In this way, after the parameters are set in this way, the first matrix of the matrix multiplication operator can be mapped to a two-dimensional matrix of the input data of the convolution operator, and the two-dimensional matrix includes only the width or height dimension and the channel dimension of the input data of the convolution operator.

The step 420 of transforming the second matrix of the matrix multiplication operator to the weight matrix of the convolution operator includes the following steps.

At step 421, mapping a count K of rows of the second matrix of the matrix multiplication operator to a count of channels of the weight matrix of the convolution operator.

At step 422, setting a width parameter and a height parameter of the weight matrix of the convolution operator to 1.

At step 423, mapping a count N of columns of the second matrix of the matrix multiplication operator to a count of kernels of the weight matrix of the convolution operator.

In other words, the two dimensions of the second matrix of the matrix multiplication operator are mapped to the channel dimension and the kernel dimension of the weight matrix of the convolution operator, respectively, i.e., the weight matrix of the convolution operator becomes a two-dimensional matrix. The width dimension and the height dimension of the weight matrix of the convolution operator are removed. Because MAC operations are performed on the width or height dimension and the channel dimension of the input data of the convolution operator with the channel dimension and the kernel dimension of the weight matrix, the MAC in the matrix multiplication may be computed using the MAC of the convolution operator to obtain the result of the matrix multiplication.

FIG. 5B illustrates a schematic diagram of a parameter mapping relationship between matrix multiplication and a convolution operator in case of mapping a count of rows of a first matrix of a matrix multiplication operator to a width parameter of an input data matrix of the convolution operator according to another embodiment of the present disclosure as illustrated in FIG. 5A.

As shown in FIG. 5B, the count M of rows of the first matrix of the matrix multiplication operator is mapped to the width parameter of the input data matrix of the convolution operator. The height parameter of the input data matrix of the convolution operator is set to 1. The count K of rows of the second matrix of the matrix multiplication operator is mapped to the count of channels of the weight matrix of the convolution operator. Both the width parameter and the height parameter of the weight matrix of the convolution operator are set to 1. The count N of columns of the second matrix of the matrix multiplication operator is mapped to the count of kernels of the weight matrix of the convolution operator.

In this way, the first matrix of the matrix multiplication operator is changed into M×1×K (i.e., M×K two-dimensional matrix) input data matrix of the convolution operator, and the second matrix of the matrix multiplication operator is changed into 1×1×K×N (i.e., K×N two-dimensional matrix) weight matrix of the convolution operator. Thus, an output matrix after convolution is a M×1×N matrix (i.e., M×N two-dimensional matrix), i.e., a computation result of the matrix multiplication operator.

Therefore, as shown in FIG. 5B, the data output width parameter of an output data matrix (or referred to as a result matrix) is M, the data output height parameter of the output data matrix is 1, and the data output channel parameter of the output data matrix is N.

The settings of the parameters are introduced above. According to the above settings of the parameters, the first matrix and the second matrix of the matrix multiplication operator can be actually transformed to the input data matrix and the weight matrix of the convolution operator.

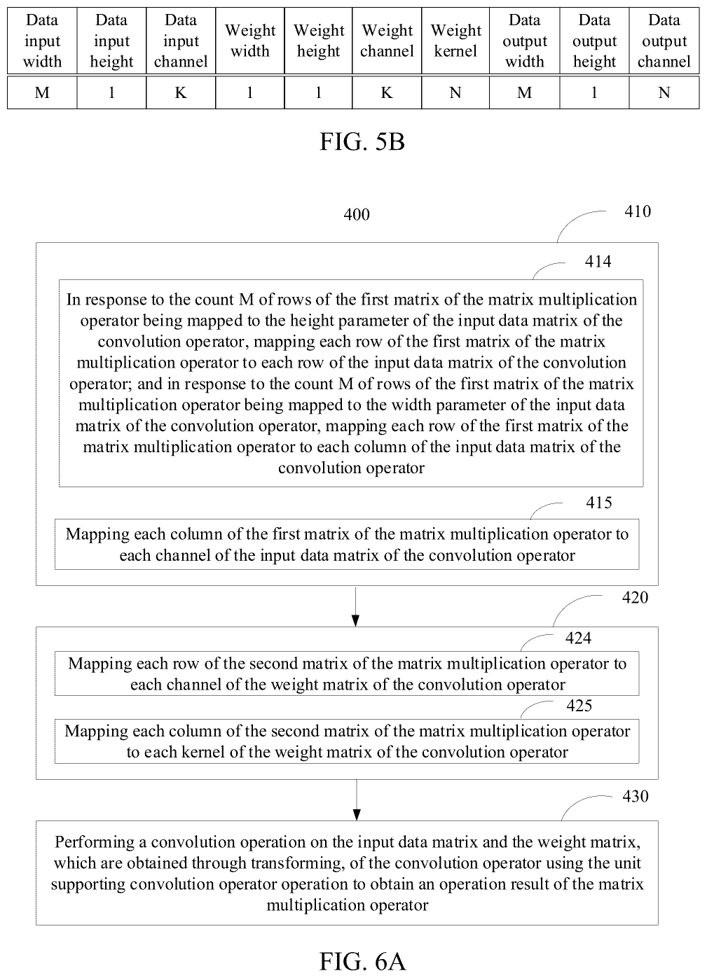

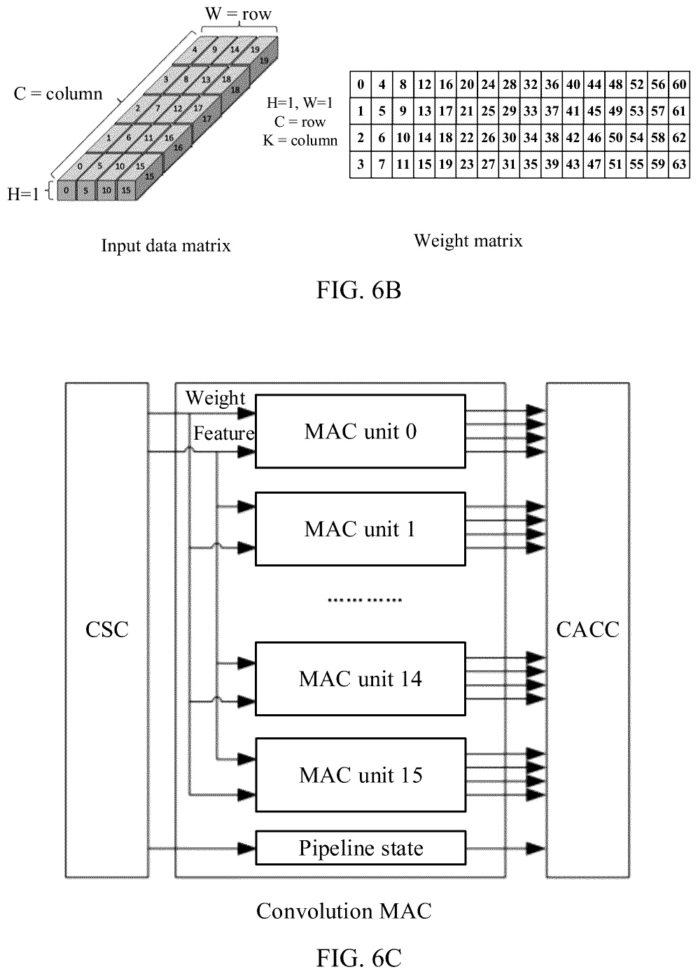

FIG. 6A illustrates another flowchart of a method 400 for performing a matrix multiplication operator using a unit supporting convolution operator operation according to another embodiment of the present disclosure.

In addition to the steps shown in FIG. 5A, the step 410 of transforming the first matrix of the matrix multiplication operator to the input data matrix of the convolution operator further includes the following steps.

At step 414, in response to the count M of rows of the first matrix of the matrix multiplication operator being mapped to the height parameter of the input data matrix of the convolution operator, mapping each row of the first matrix of the matrix multiplication operator to each row of the input data matrix of the convolution operator; and in response to the count M of rows of the first matrix of the matrix multiplication operator being mapped to the width parameter of the input data matrix of the convolution operator, mapping each row of the first matrix of the matrix multiplication operator to each column of the input data matrix of the convolution operator.

At step 415, mapping each column of the first matrix of the matrix multiplication operator to each channel of the input data matrix of the convolution operator.

It should be noted that in the present disclosure, “mapping each row of the first matrix of the matrix multiplication operator to each row of the input data matrix of the convolution operator” indicates mapping respective rows of the first matrix of the matrix multiplication operator to respective row of the input data matrix of the convolution operator, respectively, that is, one row of the first matrix of the matrix multiplication operator is mapped to one row of the input data matrix of the convolution operator. Similarly, “mapping each row of the first matrix of the matrix multiplication operator to each column of the input data matrix of the convolution operator” indicates mapping respective rows of the first matrix of the matrix multiplication operator to respective columns of the input data matrix of the convolution operator, respectively; “mapping each column of the first matrix of the matrix multiplication operator to each channel of the input data matrix of the convolution operator” indicates mapping respective columns of the first matrix of the matrix multiplication operator to respective channels of the input data matrix of the convolution operator, respectively.

In this way, the first matrix of the matrix multiplication operator is actually changed into a M×1×K (i.e., M×K two-dimensional matrix) input data matrix of the convolution operator.

In addition to the steps shown in FIG. 5A, the step 420 of transforming the second matrix of the matrix multiplication operator to the weight matrix of the convolution operator further includes the following steps.

At step 424, mapping each row of the second matrix of the matrix multiplication operator to each channel of the weight matrix of the convolution operator.

At step 425, mapping each column of the second matrix of the matrix multiplication operator to each kernel of the weight matrix of the convolution operator.

FIG. 6B illustrates a schematic diagram of an input data matrix and a weight matrix of a convolution operator to which a first matrix and a second matrix of a matrix multiplication operator are mapped.

FIG. 6B illustrates, on the left side, the input data matrix of the convolution operator to which the first matrix of the matrix multiplication operator is mapped, width W=M, height H=1, and channel C=K. Apparently, the input data matrix is a two-dimensional matrix.

FIG. 6B illustrates, on the right side, the weight matrix of the convolution operator to which the second matrix of the matrix multiplication operator is mapped, width W=1, height H=1, channel C=K, and Kernel=N. Apparently, the weight matrix is also a two-dimensional matrix. As a matter of course, note that this is merely an example, not a limitation.

In this way, the second matrix of the matrix multiplication operator is actually changed into a 1×1×K×N (i.e., K×N two-dimensional matrix) weight matrix of the convolution operator.

Thus, the output matrix after convolution is M×1×N (i.e., M×N two-dimensional matrix), i.e., a computation result of the matrix multiplication operator.

In this way, a unit supporting the convolution operator can be applied to the first matrix and the second matrix of the matrix multiplication operator to obtain the result of the matrix multiplication operator through the convolution process.

The following describes how the above-described mapping of the matrix multiplication operator to the convolution operator and performing a convolution computation are actually implemented on deep learning accelerator (DLA) hardware.

The data formats of the matrices (hereinafter, the matrices refer to the two matrices of the matrix multiplication operator) for matrix multiplication can be directly supported on the DLA hardware, thus avoiding the overhead of first converting a matrix format to a Conv data format and then loading as the input data cube and the weight cube of the convolution operator and improving the performance. In other words, the DLA hardware supporting the convolution operator is utilized to directly fetch and load the elements of the two matrices of the matrix multiplication operator stored in a memory as the input data cube and the weight cube of the convolution operator. Thus, the hardware and software overheads can be saved and the computing performance can be improved.

The support for the matrix format requires considering matrices stored in two orders: a row-major order and a column-major order. A start address of matrix data in a memory may not be aligned with a memory access interface designed for the hardware. Modules for performing format conversion and processing on the order and alignment of matrices may be implemented on hardware to meet the processing requirements of data loading and data storage modules. Inline processing can be performed at a convolution direct memory access (CDMA) module that loads the input data and a write direct memory access (WDMA) module that stores the result data, or processing can be performed by using a dedicated format conversion module that is independent and capable of working in parallel with the CDMA and/or WDMA module(s).

After data is loaded by the DLA, the data may be firstly stored in an on-chip buffer for processing and use by an operation unit, and the size of each data item in the buffer is usually determined by a scale of a MAC operation array and also affects the processing logic of a matrix data loading module.

The order/alignment requirements of the CDMA and WDMA modules for the matrix format and the processing logic of matrix data loading/storage are listed below.

As described above, during storage, only 64 pieces of channel data need to be stored on each memory bank. It is assumed that if the data format of the channel data is int16 (i.e., occupying 2 bytes), each data item of an internal buffer for storing the loaded data is 128 bytes.

An input data matrix loading module of the CDMA supports a matrix in the row-major order, requiring that the start address and a column parameter of the matrix are 32-byte aligned, i.e., ensuring that the start address of each row is 32-byte aligned. The input data matrix may be firstly processed by an upstream module into the format meeting the above requirements. Here, the 32 bytes are determined by a structure of a multiply-accumulate unit supporting convolution operator operation.

FIG. 6C illustrates a schematic diagram of performing convolution by a matrix multiplication (i.e., MAC) unit of a unit supporting Conv operator operation.

A structure of a MAC unit has 32 MAC units (not all units are shown) in case of the data format being int8 and has 16 MAC units (as shown in FIG. 6C) in case of the data format being int16. Each MAC unit multiplies a weight and a feature that are input, and inputs a result of multiplication to a convolution accumulator for accumulation. As shown in FIG. 6C, features and weights output from a convolution sequence controller (CSC) can be computed in parallel by 16 MAC units at a time to obtain 16 accumulation results, and finally the 16 accumulation results are written to convolution accumulator (CACC). Each accumulation result has original accuracy, which is 1 byte in case of the data format being int8 and 2 bytes in case of the data format being int16. Therefore, the structure of the MAC unit makes it possible to compute 32 bytes at a time.

In other words, the structure of the MAC unit allows that the data of 32 bytes can be processed during each MAC operation. Therefore, it is required that the start address and the column parameter of a matrix are 32-byte aligned. Thus, the data of 32 bytes can be processed each time. As a matter of course, the 32 bytes is only an example, and other byte sizes may also be possible.

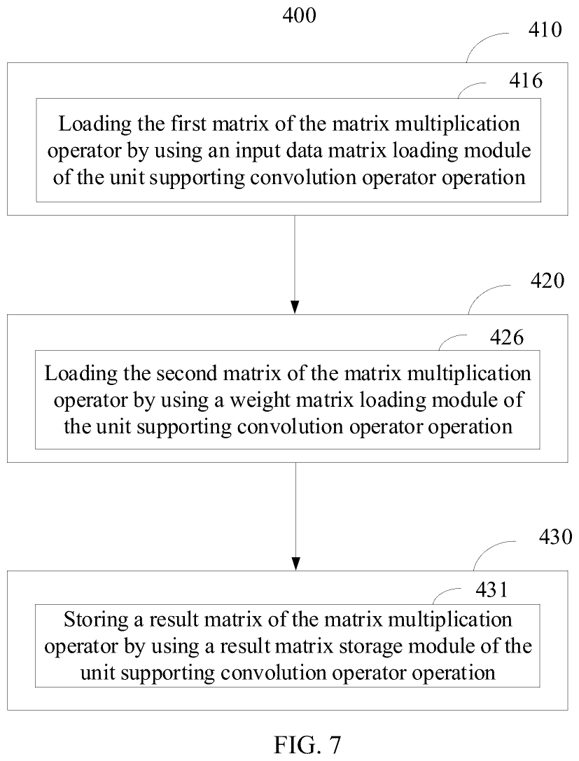

FIG. 7 illustrates a flowchart of directly supporting a data format of a matrix for matrix multiplication on deep learning accelerator (DLA) hardware in performing a matrix multiplication operator using a unit supporting convolution operator operation according to another embodiment of the present disclosure.

As shown in FIG. 7, the step 410 of transforming the first matrix of the matrix multiplication operator to the input data matrix of the convolution operator further includes: step 416, loading the first matrix of the matrix multiplication operator by using an input data matrix loading module of the unit supporting convolution operator operation.

The step 420 of transforming the second matrix of the matrix multiplication operator to the weight matrix of the convolution operator further includes: step 426, loading the second matrix of the matrix multiplication operator by using a weight matrix loading module of the unit supporting convolution operator operation.

The step 430 of performing a convolution operation on the input data matrix and the weight matrix, which are obtained through transforming, of the convolution operator using the unit supporting convolution operator operation to obtain an operation result of the matrix multiplication operator includes: step 431, storing a result matrix of the matrix multiplication operator by using a result matrix storage module of the unit supporting convolution operator operation. The operation result of the matrix multiplication operator comprises the result matrix of the matrix multiplication operator.

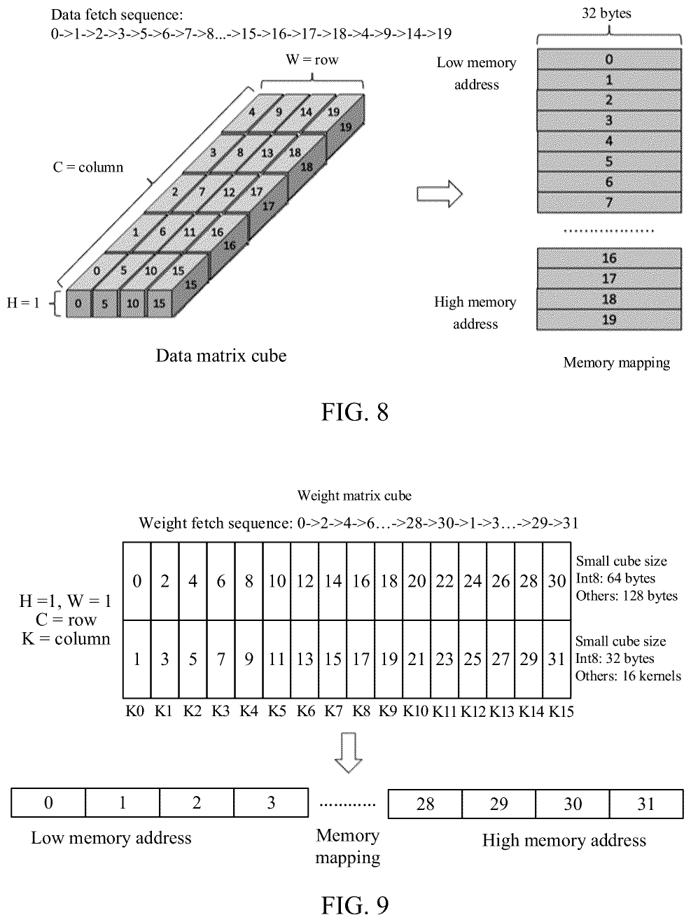

Next, the process of directly supporting the data formats of the matrices for matrix multiplication on the DLA hardware is specifically described with reference to FIG. 8 to FIG. 10.

FIG. 8 illustrates a schematic diagram of a fetch sequence and memory mapping of a first matrix of a matrix multiplication operator according to an embodiment of the present disclosure.

The step 416 of loading the first matrix of the matrix multiplication operator by using the input data matrix loading module of the unit supporting convolution operator operation includes: aligning a start address of each row of the first matrix of the matrix multiplication operator according to a first predetermined size, the first predetermined size being associated with a structure of a multiply-accumulate unit supporting convolution operator operation; dividing data of each row of the first matrix of the matrix multiplication operator into small cubes of a second predetermined size, the second predetermined size being a predetermined multiple of the first predetermined size; and loading the first matrix of the matrix multiplication operator in a nested loop order, from an inner loop to an outer loop, of the small cubes, rows, and columns of the first matrix of the matrix multiplication operator.

In particular, the first predetermined size is 32 bytes. Here, the structure of the multiply-accumulate unit allows that the data of 32 bytes can be processed during each multiply-accumulate operation. Therefore, the first predetermined size is associated with the structure of the multiply-accumulate unit supporting convolution operator operation.

As shown in FIG. 8, taking the data accuracy of int16 as an example, each row (corresponding to the channel parameter of the input data matrix of the convolution operator, a total of 4 channels) of the first matrix of the matrix multiplication operator is divided into 128-byte small cubes (no matter how many elements the first matrix has, concatenate the data sizes of these elements, and the overall data is divided into a plurality of 128-byte small cubes). If the column parameter of the original input data matrix before format processing is not 32-byte aligned, the CDMA module stores the last data in a buffer after appending 0 in the last data according to 32-byte alignment, and finally, a write pointer of the buffer is updated in 128-byte alignment.

As shown on the left side in FIG. 8, taking the data accuracy of int16 as an example, because the size of each of elements 0, 1, 2, . . . , 18, and 19 in the first matrix is 32 bytes, in case of dividing each row of the first matrix of the matrix multiplication operator into 128-byte small cubes, the first cube in the first row is composed of elements 0, 1, 2, and 3, the second cube in the first row is composed of element 4, the first cube in the second row is composed of elements 5, 6, 7, and 8, the second cube in the second row is composed of element 9, the first cube in the third row is composed of elements 10, 11, 12, and 13, the second cube in the third row is composed of element 14, the first cube in the fourth row is composed of elements 15, 16, 17, and 18, and the second cube in the fourth row is composed of element 19.

The fetch sequence of the input data matrix is: small cube->row->column. That is, the first matrix of the matrix multiplication operator is loaded as the input data matrix according to the nested loop order, from an inner loop to an outer loop, of the small cubes, rows, and columns of the first matrix of the matrix multiplication operator.

The nested loop order, from the inner loop to the outer loop, of the small cubes, the rows, and the columns means that the outermost loop is the columns, the middle loop is the rows, and the innermost loop is the small cubes. In other words, taking the data accuracy of int16 as an example, as shown in FIG. 8, firstly, the first small cube (composed of elements 0, 1, 2, and 3) of the first column (here, the first column is in units of 128-byte cube) and the first row is fetched, and then the small cube (composed of elements 5, 6, 7, and 8) of the first column and the second row is fetched, and then the small cube (composed of elements 10, 11, 12, and 13) of the first column and the third row is fetched, and then the small cube (composed of elements 15, 16, 17, and 18) of the first column and the fourth row is fetched, and then the small cube (composed of element 4) of the second column and the first row is fetched, and then the small cube (composed of element 9) of the second column and the second row is fetched, and then the small cube (composed of element 14) of the second column and the third row is fetched, and then the small cube (composed of element 19) of the second column and the fourth row is fetched.

Therefore, originally, the first matrix of the matrix multiplication operator is sequentially stored as 0, 1, 2, 3, 4, 5, 6, 7, . . . 16, 17, 18, and 19 from a low memory address to a high memory address in the memory. The data fetch sequence according to the nested loop order, from the inner loop to the outer loop, of the small cubes, the rows, and the columns is 0->1->2->3->5->6->7->8->10->11->12->13->15->16->17->18- >4->9->14->19.

In this way, the first matrix of the matrix multiplication operator is loaded by using the input data matrix loading module of the unit supporting convolution operator operation.

FIG. 9 illustrates a schematic diagram of a fetch sequence and memory mapping of a second matrix of a matrix multiplication operator according to an embodiment of the present disclosure.

The step 426 of loading the second matrix of the matrix multiplication operator by using a weight matrix loading module of the unit supporting convolution operator operation includes: aligning a start address of each column of the second matrix of the matrix multiplication operator according to a first predetermined size, the first predetermined size being associated with a structure of a multiply-accumulate unit supporting convolution operator operation; dividing all columns of the second matrix of the matrix multiplication operator into a plurality of fetch groups, each fetch group including a third predetermined number of columns; dividing data of each column of the second matrix of the matrix multiplication operator into small cubes of a second predetermined size, the second predetermined size being a predetermined multiple of the first predetermined size; and loading the second matrix of the matrix multiplication operator in a nested loop order, from an inner loop to an outer loop, of the small cubes of the second matrix of the matrix multiplication operator, columns and rows of one fetch group, and columns of all the fetch groups.

Here, because a hardware interface used for weight matrix loading is consistent with that for data matrix loading, the first predetermined size is also 32 bytes. Because the structure of the multiply-accumulate unit allows that the data of 32 bytes can be processed during each multiply-accumulate operation. Therefore, the first predetermined size is associated with the structure of the multiply-accumulate unit supporting convolution operator operation. The weight matrix loading module of the CDMA supports a matrix in the column-major order, requiring that the start address and a row parameter of the second matrix are 32-byte aligned, i.e., ensuring that the start address of each column is 32-byte aligned. The weight matrix can be firstly processed by an upstream module into the format meeting the above requirements. The fetch sequence and the memory mapping of the weight matrix and the fetch requirements for different accuracies are shown in FIG. 9.

All the columns (corresponding to the kernel parameter) of the second matrix are divided into fetch groups. For the data format int8, each group includes 32 (i.e., the third predetermined number) columns, and for other accuracy int16/fp16, each group includes 16 (i.e., the third predetermined number) columns, and the last group may include fewer columns. Each row (corresponding to the channel parameter, a total of 4 channels) of the second matrix is divided into small cubes. The small cube size of int8 is 64 bytes (i.e., the second predetermined size), and the small cube size of the other accuracies int16/fp16/fp32 is 128 bytes (i.e., the second predetermined size). If the row parameter of the original weight matrix before format processing is not 32-byte aligned, the CDMA module stores the last small cube in the buffer after appending 0 in the last small cube according to 32-byte alignment.

Note that unlike FIG. 8, to simplify the description, 0, 1, 2, 3, 4, . . . , 31 shown in FIG. 9 are divided small cubes rather than elements themselves shown in FIG. 8.

The fetch sequence of the weight matrix is: small cube->column (one fetch group)->row->column (all fetch groups). There is no alignment requirement between groups. Taking the data accuracy of int16 as an example, the CDMA appends 0 after the last group according to 128-byte alignment.

The nested loop order, from the inner loop to the outer loop, of the small cubes, the columns and rows of one fetch group, and the columns of all the fetch groups means that the outermost loop is the columns of all the fetch groups, the inner loop is the rows, the further inner loop is the columns in one fetch group, and the innermost loop is the small cubes.

As shown in FIG. 9, taking the data accuracy of int16 as an example, one fetch group has 16 columns (FIG. 9 illustrates the case of just one fetch group, and if there are other columns, they are divided into fetch groups in accordance with a rule of one fetch group having 16 columns). Each row of the second matrix is divided into 128-byte small cubes, the first small cube (equivalent to the first column in units of small cube) of the first row of the second matrix is 0, the second small cube (equivalent to the second column in units of small cube) of the first row of the second matrix is 2, the third small cube of the first row of the second matrix is 4, the fourth small cube of the first row of the second matrix is 6, the first small cube of the second row of the second matrix is 1, the second small cube of the second row of the second matrix is 3, and so on, and the sixteenth small cube of the second row of the second matrix is 31.

According to the fetch sequence, which is the nested loop order, from the inner loop to the outer loop, of small cube->column (one fetch group)->row->column (all fetch groups), it is as follows: 0->2->4->6->8->10->12->14 . . . ->30->1->3->5->7 . . . ->25->27->29->31. Then, if there is a second fetch group (not shown), the second fetch group continues to be fetched in the nested loop order above.

In this way, the second matrix of the matrix multiplication operator is located by using the weight matrix loading module of the unit supporting convolution operator operation.

In this way, the DLA hardware supporting the convolution operator is utilized to directly fetch and load the elements of the two matrices of the matrix multiplication operator stored in a memory as the input data cube and the weight cube of the convolution operator. Thus, the hardware and software overheads can be saved and the computing performance can be improved.

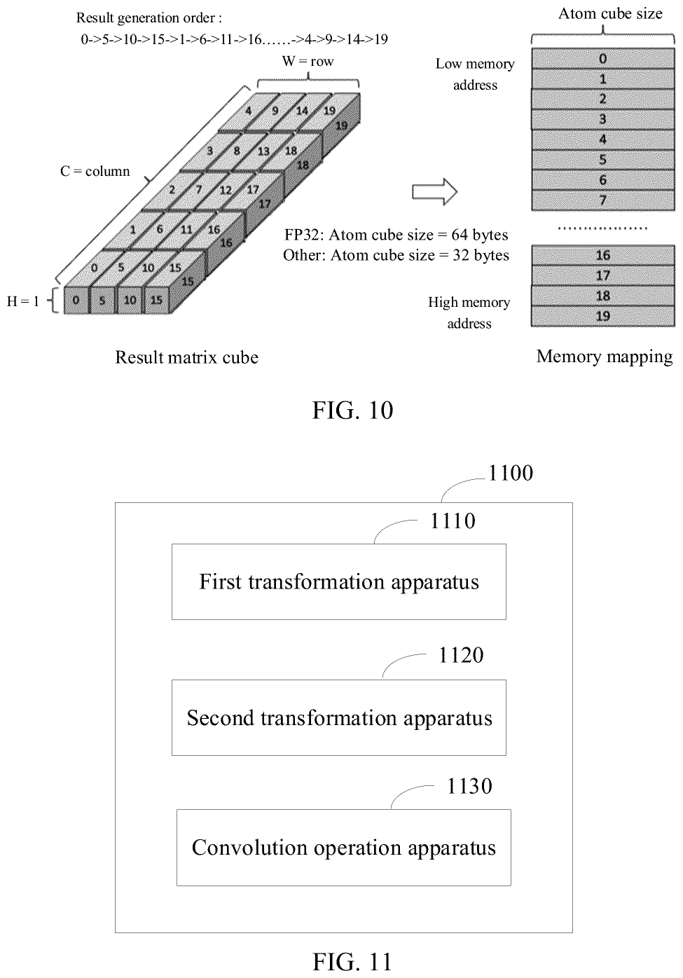

FIG. 10 illustrates a schematic diagram of a storage order and memory mapping of a result matrix of a matrix multiplication operator according to an embodiment of the present disclosure.

In the convolution computation process of the DLA hardware supporting the convolution operator, result data of the result matrix of the matrix multiplication operator is a plurality of atom cubes generated at a first predetermined size as granularity, the first predetermined size is associated with a structure of a multiply-accumulate unit supporting convolution operator operation, and the storing a result matrix of the matrix multiplication operator by using a result matrix storage module of the unit supporting convolution operator operation includes: storing the result matrix of the matrix multiplication operator in a nested loop order, from an inner loop to an outer loop, of the atom cubes, rows, and columns of the result matrix of the matrix multiplication operator.

The result matrix storage module of the WDMA supports storing the result matrix of matrix multiplication into the memory in the row-major order. A result generation sequence and memory mapping of the result matrix are shown in FIG. 10. The operation unit will generate result data according to the granularity of atom cube. The atom cube size for the data accuracy fp32 is 64 bytes (i.e., the first predetermined size), and the atom cube size for other accuracy, e.g., int16, is 32 bytes. If the column parameter is not aligned by the atom cube size, the operation unit appends 0 to align with the atom cube size. The result generation sequence of the result matrix is: atom cube->row->column.

The nested loop order, from the inner loop to the outer loop, of the atom cubes, the rows, and the columns refers to that the outermost loop is the columns, the inner loop is the rows, and the innermost loop is the atom cubes. As shown in FIG. 10, unlike FIG. 8, the numbers 0, 1, 2, 3 . . . represent the respective atom cubes rather than elements themselves. Therefore, the result generation sequence is: atom cube 0 of the first row of the first column, followed by atom cube 5 of the second row of the first column, atom cube 10 of the third row of the first column, atom cube 15 of the fourth row of the first column, atom cube 1 of the first row of the second column, atom cube 6 of the second row of the second column, . . . atom cube 4 of the first row of the fifth column, atom cube 9 of the second row of the fifth column, atom cube 14 of the third row of the fifth column, and atom cube 19 of the fourth row of the fifth column. That is, a result generation order is 0->5->10->15->1->6->11->16 . . . ->4->9->14->19.

In this way, the DLA hardware supporting the convolution operator is utilized to store the result matrix. Thus, the hardware and software overheads can be saved and the computing performance can be improved.

To sum up, the DLA hardware supporting the convolution operator is utilized to directly fetch and load the elements of the two matrices of the matrix multiplication operator stored in a memory as the input data cube and the weight cube of the convolution operator, and store the result matrix. Thus, the hardware and software overheads can be saved and the computing performance can be improved.

FIG. 11 illustrates a block diagram of a system 1100 for performing a matrix multiplication operator using a unit supporting convolution operator operation according to an embodiment of the present disclosure.

As shown in FIG. 11, a system 1100 for performing a matrix multiplication operator using a unit supporting convolution operator operation includes: a first transformation apparatus 1110 configured to transform a first matrix of the matrix multiplication operator to an input data matrix of a convolution operator; a second transformation apparatus 1120 configured to transform a second matrix of the matrix multiplication operator to a weight matrix of the convolution operator, where matrix multiplication is performed on the first matrix and the second matrix; and a convolution operation apparatus 1130 configured to perform a convolution operation on the input data matrix and the weight matrix, which are obtained through transforming, of the convolution operator using the unit supporting convolution operator operation to obtain an operation result of the matrix multiplication operator.

In this way, because the matrix multiplication operator has a large number of multiply-accumulate (MAC) computations like the convolution operator and the multiply-accumulate of the convolution operator is mainly reflected in the multiply-accumulate between the input data matrix and the weight matrix of the convolution operator, the first matrix of the matrix multiplication operator is transformed to the input data matrix of the convolution operator and the second matrix of the matrix multiplication operator is transformed to the weight matrix of the convolution operator, and then the unit supporting convolution operator operation can be used to perform the convolution operation on the input data matrix and the weight matrix, which are obtained through transforming, of the convolution operator to obtain the operation result of the matrix multiplication operator, thus saving hardware and software overheads and improving the computing performance.

In one embodiment, the first transformation apparatus 1110 is configured to: map a count M of rows of the first matrix of the matrix multiplication operator to one parameter of a width parameter or a height parameter of the input data matrix of the convolution operator, and set the other parameter of the width parameter or the height parameter of the input data matrix of the convolution operator to 1; and map a count K of columns of the first matrix of the matrix multiplication operator to a count of channels of the input data matrix of the convolution operator. M and K are positive integers.

In this way, after the parameters are set in this way, the first matrix of the matrix multiplication operator can be mapped to the two-dimensional matrix of the input data of the convolution operator, and the two-dimensional matrix includes only the width or height dimension and the channel dimension of the input data of the convolution operator.

In one embodiment, the first transformation apparatus 1110 is further configured to: in response to the count M of rows of the first matrix of the matrix multiplication operator being mapped to the height parameter of the input data matrix of the convolution operator, map each row of the first matrix of the matrix multiplication operator to each row of the input data matrix of the convolution operator; in response to the count M of rows of the first matrix of the matrix multiplication operator being mapped to the width parameter of the input data matrix of the convolution operator, map each row of the first matrix of the matrix multiplication operator to each column of the input data matrix of the convolution operator; and map each column of the first matrix of the matrix multiplication operator to each channel of the input data matrix of the convolution operator.

In this way, the first matrix of the matrix multiplication operator is actually changed into M×1×K (i.e., M×K two-dimensional matrix) input data matrix of the convolution operator.

In one embodiment, the second transformation apparatus 1120 is configured to: map a count K of rows of the second matrix of the matrix multiplication operator to a count of channels of the weight matrix of the convolution operator, and set a width parameter and a height parameter of the weight matrix of the convolution operator to 1; and map a count N of columns of the second matrix of the matrix multiplication operator to a count of kernels of the weight matrix of the convolution operator. N is a positive integer.

In other words, the two dimensions of the second matrix of the matrix multiplication operator are mapped to the channel dimension and the kernel dimension of the weight matrix of the convolution operator, respectively, i.e., the weight matrix of the convolution operator becomes a two-dimensional matrix. The width dimension and the height dimension of the weight matrix of the convolution operator are removed. Because MAC operations are performed on the width or height dimension and the channel dimension of the input data of the convolution operator with the channel dimension and the kernel dimension of the weight matrix, the MAC in the matrix multiplication may be computed using the MAC of the convolution operator to obtain the result of the matrix multiplication.

In one embodiment, the second transformation apparatus 1120 is further configured to: map each row of the second matrix of the matrix multiplication operator to each channel of the weight matrix of the convolution operator; and map each column of the second matrix of the matrix multiplication operator to each kernel of the weight matrix of the convolution operator.

In this way, the first matrix of the matrix multiplication operator is changed into M×1×K (i.e., M×K two-dimensional matrix) input data matrix of the convolution operator, and the second matrix of the matrix multiplication operator is changed into 1×1×K×N (i.e., K×N two-dimensional matrix) weight matrix of the convolution operator. Thus, an output matrix after convolution is a M×1×N matrix (i.e., M×N two-dimensional matrix), i.e., a computation result of the matrix multiplication operator. In this way, a unit supporting the convolution operator can be applied to the first matrix and the second matrix of the matrix multiplication operator to obtain the result of the matrix multiplication operator through the convolution process.

In one embodiment, the first transformation apparatus 1110 includes: an input data matrix loading module (not shown) of the unit supporting convolution operator operation, configured to load the first matrix of the matrix multiplication operator.

The second transformation apparatus 1120 includes: a weight matrix loading module (not shown) of the unit supporting convolution operator operation, configured to load the second matrix of the matrix multiplication operator.

The convolution operation apparatus 1130 includes: a result matrix storage module (not shown) of the unit supporting convolution operator operation, configured to store a result matrix of the matrix multiplication operator.

In one embodiment, the input data matrix loading module is configured to: align a start address of each row of the first matrix of the matrix multiplication operator according to a first predetermined size, the first predetermined size being associated with a structure of a multiply-accumulate unit supporting convolution operator operation; divide data of each row of the first matrix of the matrix multiplication operator into small cubes of a second predetermined size, where the second predetermined size is a predetermined multiple of the first predetermined size; and load the first matrix of the matrix multiplication operator in a nested loop order, from an inner loop to an outer loop, of the small cubes, rows, and columns of the first matrix of the matrix multiplication operator.

In this way, the first matrix of the matrix multiplication operator is loaded using the input data matrix loading module of the unit supporting convolution operator operation.

In one embodiment, the weight matrix loading module is configured to: align a start address of each column of the second matrix of the matrix multiplication operator according to a first predetermined size, the first predetermined size being associated with a structure of a multiply-accumulate unit supporting convolution operator operation; divide all columns of the second matrix of the matrix multiplication operator into a plurality of fetch groups, where each fetch group includes a third predetermined number of columns; divide data of each column of the second matrix of the matrix multiplication operator into small cubes of a second predetermined size, where the second predetermined size is a predetermined multiple of the first predetermined size; and load the second matrix of the matrix multiplication operator in a nested loop order, from an inner loop to an outer loop, of the small cubes of the second matrix of the matrix multiplication operator, columns and rows of one fetch group, and columns of all the fetch groups.

In this way, the second matrix of the matrix multiplication operator is located using the weight matrix loading module of the unit supporting convolution operator operation.

In this way, the DLA hardware supporting the convolution operator is utilized to directly fetch and load the elements of the two matrices of the matrix multiplication operator stored in a memory as the input data cube and the weight cube of the convolution operator. Thus, the hardware and software overheads can be saved and the computing performance can be improved.

In one embodiment, result data of the result matrix of the matrix multiplication operator is a plurality of atom cubes generated at a first predetermined size as granularity, the first predetermined size is associated with a structure of a multiply-accumulate unit supporting convolution operator operation, and the result matrix storage module is configured to: store the result matrix of the matrix multiplication operator in a nested loop order, from an inner loop to an outer loop, of the atom cubes, rows, and columns of the result matrix of the matrix multiplication operator.

In this way, the DLA hardware supporting the convolution operator is utilized to store the result matrix. Thus, the hardware and software overheads can be saved and the computing performance can be improved.

To sum up, the DLA hardware supporting the convolution operator is utilized to directly fetch the elements of the two matrices of the matrix multiplication operator stored in a memory and load them as the input data cube and the weight cube of the convolution operator, and store the result matrix. Thus, the hardware and software overheads can be saved and the computing performance can be improved.

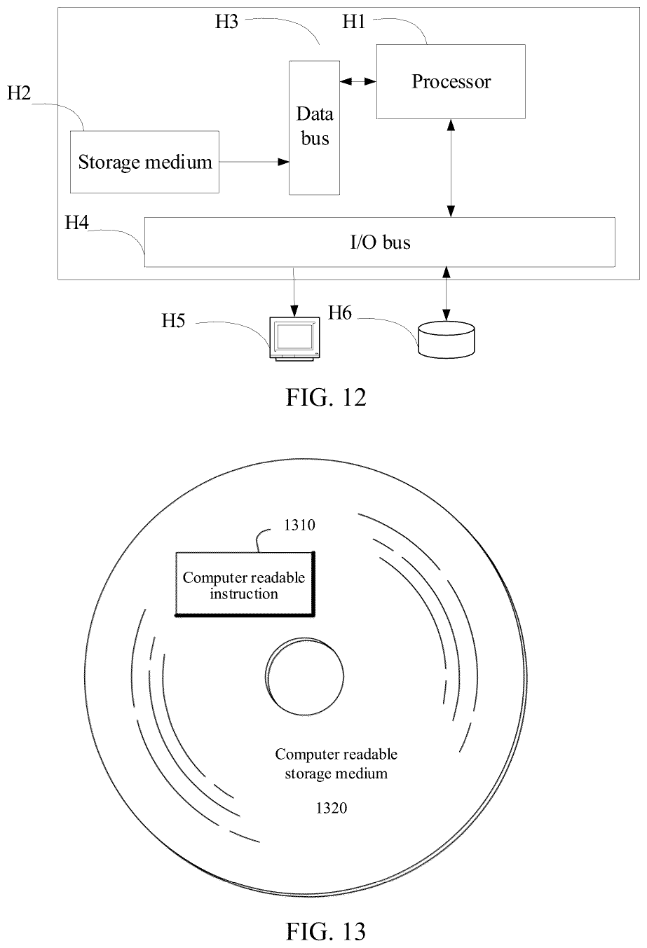

FIG. 12 illustrates a block diagram of an example electronic device suitable to implement an embodiment of the present disclosure.

The electronic device can include: a processor (H1); and a storage medium (memory) (H2) coupled to the processor (H1) and storing therein computer executable instructions. The computer executable instructions, when executed by the processor, are used to perform the steps of the methods of the embodiments of the present disclosure.

The processor (H1) may include, but be not limited to, e.g., one or more processors or microprocessors.

The storage medium (H2) may include, but be not limited to, e.g., a random access memory (RAM), a read-only memory (ROM), a flash memory, an erasable programmable read-only memory (EPROM), an electrically erasable programmable read-only memory (EEPROM), a register, and a computer storage medium (such as a hard disk, a floppy disk, a solid state disk, a removable disk, a compact disc ROM (CD-ROM), a digital versatile disc ROM (DVD-ROM), and a blue-ray disc).

In addition, the electronic device may further include (but is not limited to) a data bus (H3), an input/output (I/O) bus (H4), a display (H5), and an input/output device (H6) (e.g., a keyboard, a mouse, a loudspeaker), etc.

The processor (H1) can communicate with external devices (H5, H6, etc.) by the I/O bus (H4) via a wired or wireless network (not shown).

The storage medium (H2) may also store at least one computer executable instruction for performing, when run by the processor (H1), the various functions and/or the steps of the methods in the embodiments described in the present disclosure.

In one embodiment, the at least one computer executable instruction can also be compiled into or form a software product, and one or more computer executable instructions, when run by the processor, perform the various functions and/or the steps of the methods in the embodiments described in the present disclosure.

FIG. 13 illustrates a schematic diagram of a non-transitory computer readable storage medium according to an embodiment of the present disclosure.

As shown in FIG. 13, an instruction is stored on the computer readable storage medium 1320. The instruction is, for example, a computer readable instruction 1310. When the computer readable instruction 1310 is run by a processor, the various methods described with reference to the above can be performed. The computer readable storage medium comprises, but is not limited to, volatile memory and/or non-volatile memory. The volatile memory may comprise, for example, a random access memory (RAM) and/or a cache or the like. The non-volatile memory may comprise, for example, a read only memory (ROM), a hard disk, a flash memory, and the like. For example, the computer readable storage medium 1320 may be connected to a computing device such as a computer. Next, in the case that the computing device runs the computer readable instruction 1310 stored on the computer readable storage medium 1320, the methods as described above may be performed.

As a matter of course, the above specific embodiments are merely examples without limitation, and a person skilled in the art can merge and combine some steps and devices from the embodiments described above separately according to the concept of the present disclosure to achieve the effects of the present disclosure. Such embodiments obtaining by merging and combining are also included in the present disclosure, and such merges and combinations will not be described here one by one.

Note that the advantages, properties, effects, and the like mentioned in the present disclosure are only exemplary and not limited. It cannot be considered that these advantages, properties, effects, and the like are necessary for each embodiment of the present disclosure. In addition, the specific details disclosed above are only for the purpose of illustration and explanation, rather than limitation, and the above details do not limit the present disclosure to be implemented by the above specific details.

The blocks diagrams of the components, apparatuses, devices, and systems involved in the present disclosure are merely exemplary examples and not intended to require or imply that connection, arrangement, or configuration must be made as shown in the block diagrams. It will be recognized by those skilled in the art that these components, apparatuses, devices, and systems may be connected, arranged, or configured in any manner. The terms such as “comprise”, “include”, “have”, and their variants are open-ended terms, meaning “including but not limited to”, and may be used interchangeably therewith. As used herein, the terms “or” and “and” refer to the term “and/or”, which may be used interchangeably therewith, unless the context clearly indicates the opposite. As used herein, the term “such as” refers to the phrase “such as but not limited to”, and may be used interchangeably therewith.

The step flowcharts in the present disclosure and the above method descriptions only serve as exemplary examples and are not intended to require or imply that the steps of the embodiments must be performed in the given order. As will be recognized by a person skilled in the art, the steps in the above embodiments may be performed in any order. The words such as “followed by”, “then”, and “next” are not intended to limit the order of the steps. These words are merely used to guide readers to read through the descriptions of these methods. Moreover, any reference to a singular element using article “an”, “a”, or “the” is not construed as limiting the clement to be singular.

In addition, the steps and apparatuses in the various embodiments herein are not limited to be implemented in a certain embodiment. In fact, related partial steps and partial apparatuses in the embodiments herein can be combined according to the concept of the present disclosure to obtain new embodiments, and these new embodiments are also included within the scope of the present disclosure.

The operations of the methods described above may be performed by any suitable means that can perform corresponding functions. The means may include various hardware and/or software components and/or modules, including but not limited to: a hardware circuit, an application specific integrated circuit (ASIC), or a processor.

A general-purpose processor, a digital signal processor (DSP), an ASIC, a field programmable gate array (FPGA) or other programmable logic device (PLD), a discrete gate or transistor logic, a discrete hardware component, or any combination thereof designed to perform the functions described herein may be utilized to implement or perform the logic blocks, modules and circuits described in various examples. The general-purpose processor may be a microprocessor, but in an alternative, the processor may be any commercially available processor, controller, microcontroller, or state machine. The processor may also be implemented as a combination of computing devices, such as a combination of a DSP and a microprocessor, a plurality of microprocessors, a microprocessor cooperating with a DSP core, or any other such configuration.

The steps of the methods or algorithms described in combination with the present disclosure may be directly embedded in hardware, in a software module executed by a processor, or in a combination of both. The software module may exist in any form of tangible storage medium. Some examples of the storage medium that can be used include an RAM, an ROM, a flash memory, an EPROM, an EEPROM, a register, a hard disk, a removable disk, a CD-ROM, and the like. The storage medium can be coupled to a processor so that the processor can read information from the storage medium and write information to the storage medium. In an alternative, the storage medium can be integrated together with the processor. The software module may be a single instruction or many instructions, and may be distributed on several different code segments, between different programs, and across a plurality of storage media.

The methods disclosed herein includes actions for implementing the described methods. The methods and/or the actions may be interchanged with one another without departing from the scope of the claims. In other words, unless the specific order of the actions is specified, the order and/or use of specific actions may be modified without departing from the scope of the claims.

The above functions can be implemented in hardware, software, firmware, or any combination thereof. If implemented in software, the functions may be stored as instructions on a tangible computer readable medium. The storage medium may be any available tangible medium accessible by a computer. By way of example and not limitation, such a computer readable medium may include an RAM, an ROM, an EEPROM, a CD-ROM, or other optical disk storage, other magnetic disk storage or other magnetic storage device, or any other tangible medium that can be used to carry or store desired program code in the form of an instruction or a data structure and that can be accessed by a computer. As used herein, a disk and a disc include a compact disc (CD), a laser disc, an optical disc, a digital versatile disc (DVD), a floppy disk, and a blue-ray disc, and typically, the disk magnetically reproduces data, while the disc optically reproduces data by using laser.

Therefore, the present disclosure may also include a computer program product, and the computer program product may perform the methods, steps, and operations given herein. For example, such a computer program product may be a computer software package, a computer code instruction, a computer readable tangible medium having computer instructions tangibly stored (and/or coded) thereon, and the instructions may be executed by a processor to perform the operations described herein. The computer program product may include a packaging material.

Software or instructions may also be transmitted through a transmission medium. For example, software may be transmitted from a website, a server, or other remote source by using a transmission medium such as a coaxial cable, an optical fiber cable, a twisted pair, a digital subscriber line (DSL), or wireless technology using infrared, radio, or microwave.

Moreover, the modules and/or other suitable means for performing the methods and techniques described herein may be downloaded by a user terminal and/or a base station and/or obtained by other ways in due course. For example, such a device may be coupled to a server to facilitate the transfer of the means for performing the methods described herein. Alternatively, various methods described herein may be provided via a storage component (e.g., an RAM, an ROM, or a physical storage medium such as a CD or a floppy disk), so that a user terminal and/or a base station can obtain various methods when coupled to the device or providing the storage component to the device. Additionally, any other suitable technology for providing the methods and techniques described herein to a device may be utilized.

Other examples and implementations fall within the scope and spirit of the present disclosure and the appended claims. For example, due to the nature of software, the functions described above may be implemented using software executed by a processor, hardware, firmware, hard wiring, or any combination thereof. Features that implement functions may also be physically located at various locations, including being distributed so that part of the functions can be implemented at different physical locations. Furthermore, as used herein, including used in the claims, “or” used in the enumeration of an item starting with “at least one” indicates a separate enumeration, so that the enumeration such as “at least one of A, B, or C” means A or B or C, or AB or AC or BC, or ABC (i.e., A and B and C). Moreover, the wording “exemplary” does not mean that a described example is preferred or better than other examples.

Various changes, replacements, and alterations may be made to the techniques described herein without departing from the taught techniques defined by the appended claims. Moreover, the scope of the claims of the present disclosure is not limited to the specific aspects of processes, machines, manufactures, composition of events, means, methods, and actions described above. Processes, machines, manufactures, composition of events, means, methods, or actions that exist currently or are to be developed later and perform basically same functions or achieve basically same results with the corresponding aspects described herein may be utilized. Hence, the appended claims include such processes, machines, manufactures, composition of events, means, methods, and actions within the scope thereof.

The foregoing descriptions of the aspects of the present disclosure are provided to enable any person skilled in the art to make or use the present disclosure. The general principles defined herein may be applied to other aspects without departing from the scope of the present disclosure. Therefore, the present disclosure is not intended to be limited to the aspects shown herein, but is to be accorded with the widest scope consistent with the principles and novel features disclosed herein.

The above descriptions are made for the purposes of illustration and description. In addition, the descriptions are not intended to limit the embodiments of the present disclosure to the form disclosed herein. Although a plurality of example aspects and embodiments have been discussed above, some variations, modifications, changes, additions, and sub-combinations made thereto will be recognized by those skilled in the art.

1. A method for performing a matrix multiplication operator using a unit supporting convolution operator operation, comprising:
transforming a first matrix of the matrix multiplication operator to an input data matrix of a convolution operator;
transforming a second matrix of the matrix multiplication operator to a weight matrix of the convolution operator, wherein matrix multiplication is performed on the first matrix and the second matrix; and
performing a convolution operation on the input data matrix and the weight matrix, which are obtained through transforming, of the convolution operator using the unit supporting convolution operator operation to obtain an operation result of the matrix multiplication operator.

2. The method according to claim 1, wherein the transforming a first matrix of the matrix multiplication operator to an input data matrix of a convolution operator comprises:
mapping a count M of rows of the first matrix of the matrix multiplication operator to one parameter of a width parameter or a height parameter of the input data matrix of the convolution operator, and setting the other parameter of the width parameter or the height parameter of the input data matrix of the convolution operator to 1; and
mapping a count K of columns of the first matrix of the matrix multiplication operator to a count of channels of the input data matrix of the convolution operator, wherein M and K are positive integers.

3. The method according to claim 2, wherein the transforming a first matrix of the matrix multiplication operator to an input data matrix of a convolution operator further comprises:
in response to the count M of rows of the first matrix of the matrix multiplication operator being mapped to the height parameter of the input data matrix of the convolution operator, mapping each row of the first matrix of the matrix multiplication operator to each row of the input data matrix of the convolution operator; in response to the count M of rows of the first matrix of the matrix multiplication operator being mapped to the width parameter of the input data matrix of the convolution operator, mapping each row of the first matrix of the matrix multiplication operator to each column of the input data matrix of the convolution operator; and
mapping each column of the first matrix of the matrix multiplication operator to each channel of the input data matrix of the convolution operator.

4. The method according to claim 3, wherein the transforming a second matrix of the matrix multiplication operator to a weight matrix of the convolution operator comprises:
mapping a count K of rows of the second matrix of the matrix multiplication operator to a count of channels of the weight matrix of the convolution operator, and setting a width parameter and a height parameter of the weight matrix of the convolution operator to 1; and
mapping a count N of columns of the second matrix of the matrix multiplication operator to a count of kernels of the weight matrix of the convolution operator, wherein N is a positive integer.

5. The method according to claim 4, wherein the transforming a second matrix of the matrix multiplication operator to a weight matrix of the convolution operator further comprises:
mapping each row of the second matrix of the matrix multiplication operator to each channel of the weight matrix of the convolution operator; and
mapping each column of the second matrix of the matrix multiplication operator to each kernel of the weight matrix of the convolution operator.

6. The method according to claim 5, wherein
the transforming a first matrix of the matrix multiplication operator to an input data matrix of a convolution operator further comprises:
loading the first matrix of the matrix multiplication operator by using an input data matrix loading module of the unit supporting convolution operator operation;
wherein the transforming a second matrix of the matrix multiplication operator to a weight matrix of the convolution operator further comprises:
loading the second matrix of the matrix multiplication operator by using a weight matrix loading module of the unit supporting convolution operator operation; and
wherein the performing a convolution operation on the input data matrix and the weight matrix, which are obtained through transforming, of the convolution operator using the unit supporting convolution operator operation to obtain an operation result of the matrix multiplication operator comprises:
storing a result matrix of the matrix multiplication operator by using a result matrix storage module of the unit supporting convolution operator operation.

7. The method according to claim 6, wherein the loading the first matrix of the matrix multiplication operator by using an input data matrix loading module of the unit supporting convolution operator operation comprises:
aligning a start address of each row of the first matrix of the matrix multiplication operator according to a first predetermined size, wherein the first predetermined size is associated with a structure of a multiply-accumulate unit supporting convolution operator operation;
dividing data of each row of the first matrix of the matrix multiplication operator into small cubes of a second predetermined size, wherein the second predetermined size is a predetermined multiple of the first predetermined size; and
loading the first matrix of the matrix multiplication operator in a nested loop order, from an inner loop to an outer loop, of the small cubes, rows, and columns of the first matrix of the matrix multiplication operator.

8. The method according to claim 6, wherein the loading the second matrix of the matrix multiplication operator by using a weight matrix loading module of the unit supporting convolution operator operation comprises:
aligning a start address of each column of the second matrix of the matrix multiplication operator according to a first predetermined size, wherein the first predetermined size is associated with a structure of a multiply-accumulate unit supporting convolution operator operation;
dividing all columns of the second matrix of the matrix multiplication operator into a plurality of fetch groups, wherein each fetch group comprises a third predetermined number of columns;
dividing data of each column of the second matrix of the matrix multiplication operator into small cubes of a second predetermined size, wherein the second predetermined size is a predetermined multiple of the first predetermined size; and
loading the second matrix of the matrix multiplication operator in a nested loop order, from an inner loop to an outer loop, of the small cubes of the second matrix of the matrix multiplication operator, columns and rows of one fetch group, and columns of all the fetch groups.

9. The method according to claim 6, wherein result data of the result matrix of the matrix multiplication operator is a plurality of atom cubes generated at a first predetermined size as granularity, wherein the first predetermined size is associated with a structure of a multiply-accumulate unit supporting convolution operator operation, and wherein the storing a result matrix of the matrix multiplication operator by using a result matrix storage module of the unit supporting convolution operator operation comprises:
storing the result matrix of the matrix multiplication operator in a nested loop order, from an inner loop to an outer loop, of the atom cubes, rows, and columns of the result matrix of the matrix multiplication operator.

10. A system for performing a matrix multiplication operator using a unit supporting convolution operator operation, comprising:
a first transformation apparatus, configured to transform a first matrix of the matrix multiplication operator to an input data matrix of a convolution operator;
a second transformation apparatus, configured to transform a second matrix of the matrix multiplication operator to a weight matrix of the convolution operator, wherein matrix multiplication is performed on the first matrix and the second matrix; and
a convolution operation apparatus, configured to perform a convolution operation on the input data matrix and the weight matrix, which are obtained through transforming, of the convolution operator using the unit supporting convolution operator operation to obtain an operation result of the matrix multiplication operator.

11. The system according to claim 10, wherein the first transformation apparatus is configured to:
map a count M of rows of the first matrix of the matrix multiplication operator to one parameter of a width parameter or a height parameter of the input data matrix of the convolution operator, and set the other parameter of the width parameter or the height parameter of the input data matrix of the convolution operator to 1; and
map a count K of columns of the first matrix of the matrix multiplication operator to a count of channels of the input data matrix of the convolution operator, wherein M and K are positive integers.

12. The system according to claim 11, wherein the first transformation apparatus is further configured to:
in response to the count M of rows of the first matrix of the matrix multiplication operator being mapped to the height parameter of the input data matrix of the convolution operator, map each row of the first matrix of the matrix multiplication operator to each row of the input data matrix of the convolution operator; in response to the count M of rows of the first matrix of the matrix multiplication operator being mapped to the width parameter of the input data matrix of the convolution operator, map each row of the first matrix of the matrix multiplication operator to each column of the input data matrix of the convolution operator; and
map each column of the first matrix of the matrix multiplication operator to each channel of the input data matrix of the convolution operator.

13. The system according to claim 12, wherein the second transformation apparatus is configured to:
map a count K of rows of the second matrix of the matrix multiplication operator to a count of channels of the weight matrix of the convolution operator, and set a width parameter and a height parameter of the weight matrix of the convolution operator to 1; and
map a count N of columns of the second matrix of the matrix multiplication operator to a count of kernels of the weight matrix of the convolution operator, wherein N is a positive integer.

14. The system according to claim 13, wherein the second transformation apparatus is further configured to:
map each row of the second matrix of the matrix multiplication operator to each channel of the weight matrix of the convolution operator; and
map each column of the second matrix of the matrix multiplication operator to each kernel of the weight matrix of the convolution operator.

15. The system according to claim 14, wherein
the first transformation apparatus comprises:
an input data matrix loading module of the unit supporting convolution operator operation, configured to load the first matrix of the matrix multiplication operator;
wherein the second transformation apparatus comprises:
a weight matrix loading module of the unit supporting convolution operator operation, configured to load the second matrix of the matrix multiplication operator; and
wherein the convolution operation apparatus comprises:
a result matrix storage module of the unit supporting convolution operator operation, configured to store a result matrix of the matrix multiplication operator.

16. The system according to claim 15, wherein the input data matrix loading module is configured to:
align a start address of each row of the first matrix of the matrix multiplication operator according to a first predetermined size, wherein the first predetermined size is associated with a structure of a multiply-accumulate unit supporting convolution operator operation;
divide data of each row of the first matrix of the matrix multiplication operator into small cubes of a second predetermined size, wherein the second predetermined size is a predetermined multiple of the first predetermined size; and
load the first matrix of the matrix multiplication operator in a nested loop order, from an inner loop to an outer loop, of the small cubes, rows, and columns of the first matrix of the matrix multiplication operator.

17. The system according to claim 15, wherein the weight matrix loading module is configured to:
align a start address of each column of the second matrix of the matrix multiplication operator according to a first predetermined size, wherein the first predetermined size is associated with a structure of a multiply-accumulate unit supporting convolution operator operation;
divide all columns of the second matrix of the matrix multiplication operator into a plurality of fetch groups, wherein each fetch group comprises a third predetermined number of columns;
divide data of each column of the second matrix of the matrix multiplication operator into small cubes of a second predetermined size, wherein the second predetermined size is a predetermined multiple of the first predetermined size; and
load the second matrix of the matrix multiplication operator in a nested loop order, from an inner loop to an outer loop, of the small cubes of the second matrix of the matrix multiplication operator, columns and rows of one fetch group, and columns of all the fetch groups.

18. The system according to claim 15, wherein result data of the result matrix of the matrix multiplication operator is a plurality of atom cubes generated at a first predetermined size as granularity, wherein the first predetermined size is associated with a structure of a multiply-accumulate unit supporting convolution operator operation, and wherein the result matrix storage module is configured to:
store the result matrix of the matrix multiplication operator in a nested loop order, from an inner loop to an outer loop, of the atom cubes, rows, and columns of the result matrix of the matrix multiplication operator.

19. An electronic device, comprising:
a memory, configured to store instructions; and
a processor, configured to read and execute the instructions in the memory to perform a method for performing a matrix multiplication operator using a unit supporting convolution operator operation,
wherein the method comprises:
transforming a first matrix of the matrix multiplication operator to an input data matrix of a convolution operator;
transforming a second matrix of the matrix multiplication operator to a weight matrix of the convolution operator, wherein matrix multiplication is performed on the first matrix and the second matrix; and
performing a convolution operation on the input data matrix and the weight matrix, which are obtained through transforming, of the convolution operator using the unit supporting convolution operator operation to obtain an operation result of the matrix multiplication operator.

20. A non-transitory storage medium on which instructions are stored,
wherein the instructions, when read by a processor, causes the processor to perform the method according to claim 1.
